(19) United States
(12) Patent Application Publication
(10) Pub. No.: US 2012/0101015 A1
(43) Pub. Date: Apr. 26, 2012

(54) ANTI-WEAR AGENTS WITH A REDUCED NEUROTOXICITY

(75) Inventors: Pascal Frapin, Conflans Saint Honorine (FR); Issa Latif, Montreuil (FR); Christophe Corbun, Nesles-La-Vallee (FR); Jean-Louis Mansoux, Parmain (FR)

(73) Assignee: NYCO SA, Paris (FR)

(21) Appl. No.: 13/380,089

(22) PCT Filed: Jun. 23, 2010
(86) PCT No.: PCT/EP10/58885

§ 371 Date: Dec. 22, 2011

(30) Foreign Application Priority Data
Jun. 23, 2009 (FR) 0954258

(51) Int. Cl. C10M 137/04; C10M 133/44; C07F 9/09

(52) U.S. Cl. 508/282; 558/211; 508/433; 508/440

(57) ABSTRACT

Described is a lubricating composition of an anti-wear agent or a combination of anti-wear agents having a reduced neurotoxicity, the anti-wear agent(s) being selected from triaryl phosphate compounds preferably substituted with one or more linear or branched alkyl group(s) including from 2 to 12 carbon atoms.

### TECHNICAL FIELD OF THE INVENTION

The present invention relates to the field of lubricating compositions for aircraft turbine engines.

### STATE OF THE ART

Aircraft gas turbines require high-performance lubricating compositions which can be used within a very broad temperature range. Such compositions must satisfy aircraft industry-specific performance requirements such as those of the US Navy MIL-PRF-23699 specification. This specification determines inter alia the physico-chemical properties, the thermal stability levels, the oxidation stability levels, the oil coking tendency and the anti-wear properties of the lubricating compositions.

The lubricating compositions for aircraft gas turbines are mainly composed of high-boiling point, long chain synthetic esters. They further comprise various additives that generally account for about 1% to 10% by weight of their total weight. These additives enable either (i) to improve their physico-chemical properties (especially their stability), or (ii) to protect the mechanisms to be lubricated from any deterioration.

There are thus various additives to be discerned, such as anticorrosive agents, antioxidants, yellow metal deactivators, foam inhibitors, demulsifiers, agents for improving the load carrying capacity (also called “extreme-pressure agents”) and anti-wear agents.

A limited number of anti-wear compounds to be suitably used in lubricating compositions for aircraft turbines is described in the state of the art. Most of them are organic phosphorous or sulfur-containing compounds.

Amongst those compounds, mixtures of the meta- and para- isomers of tricresyl phosphate are very often used, optionally in combination with other anti-wear additives or with other agents for improving the load carrying capacity.

Thus, the U.S. Pat. No. 5,585,338 which describes the use of mercapto benzoic acid as an agent for improving the load carrying capacity, mentions as an anti-wear agent being suitable for lubricating compositions for aircraft turbines, hydrocarbon phosphates and very especially tricresyl phosphate.

The French patent no. 2215462 also describes an anti-wear combination comprising (i) a triaryl phosphorothionate such as triphenyl phosphorothionate and (ii) a triaryl phosphate such as tricresyl phosphate.

On the contrary, the use of cresyl phosphate ortho-isomers is inappropriate because of their neurotoxicity. The US Navy MIL-PRF-23699 standard establishes that the tri-ortho-cresyl phosphate content (TOCP) in a lubricating composition for aircraft turbines should not exceed 1% of the composition total weight.

Compounds distinct from triaryl phosphates may be suitably used in lubricating compositions for aircraft turbines.

Thus, the U.S. Pat. No. 4,514,311 describes a lubricating composition comprising as an anti-wear agent the product resulting from the reaction of a primary polyamine of the tris[ω-amino(polyalkoxy)methyl]methane type with a phosphoric acid ester or with a phosphoric acid, the phosphoric acid ester and the phosphoric acid comprising alkyl or aryl groups.

The U.S. Pat. Nos. 5,574,184 and 5,503,758 describe agents having both anti-wear and anti-oxidative activities which are obtained according to the following reaction sequence:
(i) Reacting an ether diamine with (ii) a carboxylic acid comprising one or more mercaptan group(s), and thereafter
(ii) Reacting the product obtained in step (i) with an aliphatic amine, an aliphatic compound comprising a hydroxyl group or a trialkyl phosphite.

The U.S. Pat. No. 5,512,189 also illustrates a method for preparing anti-wear agents which comprises the step of reacting a thiol group-containing carboxylic acid with an organophosphorodithioate.

Finally, the European application EP 0 612 836 discloses the use of trithiocyanuric acid as an anti-wear agent able to improve the load carrying capacity in various lubricating composition types, especially, those intended to be used in aircraft turbines.

As illustrated by Weiner and Jortner (Neurotoxicology, 1999, 20(4):653-674), the neurotoxicity of the triarylphosphates and their combinations, that are the most used in industrial fields, was assessed mostly on hen model by oral exposure. These studies show that some triarylphosphates may induce organophosphate-induced delayed neurotoxicity.

Despite these already satisfying solutions, there is still a need for new anti-wear agents and anti-wear combinations to be suitably used in lubricating compositions for aircraft turbines, which would be considered as being alternatives to or improvements as compared to the already known antiwear combinations and agents There is still also a need for new anti-wear agents and anti-wear combinations having low neurotoxicity.

### SUMMARY OF THE INVENTION

The present invention provides a new use of triaryl phosphates and combinations thereof as anti-wear agents in lubricating compositions for aircraft engine turbines.

The present invention provides the use of an anti-wear agent or a combination of anti-wear agents having a reduced neurotoxicity for preparing a lubricating composition for aircraft engines, the said anti-wear agent(s) being selected from compounds of formula A

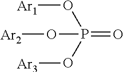

wherein Ar1, Ar2 and Ar3 represent aryl groups.

The present invention also provides a lubricating composition comprising anti-wear agent or anti-wear composition having a reduced neurotoxicity.

The present invention also provides a method for preparing said lubricating composition.

### DESCRIPTION OF THE FIGURES

FIG. 1 illustrates the chemical structure of some compounds of formula A and the names used in the present specification for designate them. R represents an alkyl group that may be equally located at a meta-, a para- or an ortho-position of the phenyl group.

FIGS. 2a, 2b and 2c correspond to the results of the derivative thermogravimetry for the anti-wear combinations Durad 150 (FIG. 1 a), Durad 125 (FIG. 1b) and Durad 620B (FIG. 1c). They illustrate the weight variation of the test sample depending on the applied temperature. X-coordinates: temperature in ° C., Y-coordinates: weight variation percentage.

FIGS. 3a, 3b, 4, 5 and 6 show the residual BChE activity versus triarylphosphate concentrations curves obtained by performing the BChE activity assay described in Example 3. For each graph, Y-coordinate relates to the percentage of residual BChE activity obtained after incubation of the enzyme in a microsomal mix comprising (i) microsomes, (ii) NADPH and (iii) triarylphosphate in a concentration ranging from 0 μg/ml to 20 μg/ml. X-coordinate relates to the concentration of triarylphosphate in the microsomal mix before adding human BChE solution (see Example 3). In all cases, the positive control is Durad 125 (empty rounds).

FIG. 3a shows the dose-effect curves for para-t-butylphenyl diphenylphosphate (filled triangles), di-para-t-butylphenyl phenylphosphate (empty squares) and tri-para-t-butylphenylphosphate (filled diamonds), obtained in the presence of human liver microsomes.

FIG. 3b shows the dose-effect curves for tri-para-t-butylphenylphosphate (filled rounds), tri-meta-t-butylphenylphosphate (empty squares) and tri-ortho-t-butylphenylphosphate (empty triangles) obtained in the presence of rat liver microsomes.

FIG. 4 shows the dose-effect curves obtained for tri-para-isopropylphenyl phosphate (filled diamonds), tri-ortho -isopropylphenyl phosphate (empty squares) and di-para-isopropylphenyl phenylphosphate (filled triangles) in the presence of rat liver microsomes.

FIG. 5 shows the dose-effect curves obtained for 1-methylnonylphenyl diphenyl phosphate (filled triangles) and dodecylphenyl diphenylphosphate (filled squares) in the presence of rat liver microsomes.

FIG. 6 shows the dose-effect curves obtained for the commercial products Syn-O-Add 8484 (filled diamonds) and Syn-O-Add 8478 (filled squares) in the presence of rat liver microsomes.

FIG. 7a and FIG. 7b show the mean percentage of residual BChE activity in rat plasma versus oral triarylphosphate dose at 6 hours and 24 hours post-dosing, respectively. For each time point and for each dose, from three to six rats were administered by gavage an appropriate dose of Durad 125 (empty squares) or of tri-para-tert-butylphenylphosphate (filled diamonds), diluted in corn oil.

X-coordinates: oral dose of triarylphosphate in mg/kg of the body weight, Y-coordinate: percentage of the mean residual ativity of BChE detected in plasma according to Ellman's method.

### DETAILED DESCRIPTION OF THE INVENTION

The applicant strived to develop new anti-wear agents and new anti-wear combinations which are suitable for use in lubricating compositions for aircraft turbines.

The applicant showed that triaryl phosphates comprising at least one alkyl radical comprising at least two carbon atoms and anti-wear combinations mainly composed of these compounds may be suitable for use as anti-wear agents in lubricating compositions for aircraft turbines.

Moreover, these compounds and their combinations have improved properties, especially a reduced neurotoxicity as compared to traditional anti-wear combinations described in the state of the art which mainly comprise triphenyl phosphate or the isomers para and meta of tricresyl phosphate.

The neurotoxicity of arylphosphate derivatives was extensively studied in the past since said compounds were extensively used in various industrial fields.

It should be noted that the tri-ortho-cresyl phosphate (TOCP) neurotoxicity has been known for a long time and was explained by Casida in 1961. The neurotoxicity of TOCP results from the presence of an ortho- methyl radical on phenyl groups, said radical enabling the TOCP to be metabolized by the hepatic cytochromes P450 into a cyclic ester. Such a cyclic ester is a powerful inhibitor of esterases and, in particular that of cholinesterase which is a key-enzyme of the central nervous system (Casida and al., 1961, Nature, 191; 1396-1397).

By the past, the delayed neurotoxicity for certain triarylphosphates was mainly assessed by subchronic studies conducted on hens by oral route (Weiner and Jortner, Neurotoxicology, 1999, 20(4):653-674). Said studies consisted in the observation of clinical signs of neurotoxicity (such as ataxia) developed in hens and in the determination of brain and spinal NTE (neuropathy target esterase) activity inhibition and nervous system lesions. In all these studies, the oral doses of triarylphosphate which were administered to hens were very high (ranging from 100 mg/kg to about 20000 mg/kg) so that the clinical signs observed in hens after triaryl phosphate administration could be interpreted as a sign of general toxicity rather than a sign of neurotoxicity. Moreover, the different studies shared neither the same experimental protocol nor the same standards to evaluate neurotoxicity so that it is very difficult to interpret and compare them a posteriori. Noticeably, the majority of these studies related to commercially available mixture of triarylphosphates so that the contribution of each individuated triarylphosphate isomer or compound could not be assessed.

Taken as a whole and from a general point of view, these studies may only suggest that triarylphosphates, in general, display a low neurotoxicity (based on the fact that clinical signs were only observed for very high oral dosages of triarylphosphates). These studies also suggest that, when observed, the neurotoxicity of triarylphosphates relies on the presence of an ortho alkyl group comprising at least one hydrogen on the alpha carbon. Accordingly, TOCP is highly neurotoxicity and triphenyl phosphate, which bears no substituant, is believed to be non neurotoxic or poorly neurotoxic (Weiner and Jortner, Neurotoxicology, 1999, 20(4):653-674).

A comprehensive neurotoxicity classification between triarylphosphates or between triarylphosphate isomers cannot be clearly established based on these studies.

Nowadays, the results of the above-described studies may be questionable. It is not clear if the subchronic and acute studies conducted on hens enable to actually anticipate the impact of a chronic exposure to low amounts of triarylphosphates via inhalation on human health. Some authors argue that the organophosphorous compounds have a poor access to their neurological target through oral route and that the most effective route by which triarylphosphates exhibit neurotoxicity is the inhalation route (Abou-Dounia, Contaminated Air

Protection Conference: Proceedings of a Conference, held at Imperial College, London,20-21 Apr. 2005, Winder, C., editor, University of New South Wales, Sydney, 2005, pp 59-90). Some others argue that triarylphosphates have a poor oral biodisponibility so that it is not clear if the differences observed in clinical signs between triarylphosphates resulted from a distinct neurotoxicity or from a distinct bioabsorption.

Accordingly, in order to evaluate triarylphosphate with more accuracy, the applicant used an in vitro assay which combined (i) the incubation of a triarylphosphate of interest or a combination of triarylphosphates of interest with human liver microsomes and (ii) then the assessment of the inhibition of human butyrylcholinesterase (BChE) activity resulting from the incubation of BChE with the product of metabolization of triarylphosphates by liver microsomes, since, as illustrated previously by Casida, the neurotoxicity of triarylphosphate mostly results from their metabolites.

The applicant confirmed the neurotoxicity of TOCP by this assay. However, this assay did further demonstrate that the presence of an ortho alkyl group comprising at least one hydrogen on the alpha carbon was not necessary to induce a significant inhibition of BChE. In particular, the Applicant showed that commercially available tricresyl phosphate combination, which did not contain any significant amount of TOCP (less than 0.1%), yet induced a significant BChE inhibition. The same results were obtained for the triphenylphosphate. Such results are thus not consistent with several previous clinical studies performed on hens.

On the other hand, the applicant showed that the BChE inactivation induced by tri-ortho-isopropylphenyl phosphate is significantly lower than that of triphenyl phosphate and that of tricresyl phosphate combinations, in spite of the presence of an hydrogen on the alpha carbons.

Against all expectation, the applicant showed through the same assay that triaryl phosphates substituted with, at least one alkyl group comprising at least two carbon atoms on ortho, meta or para position may display a neurotoxicity that is substantially lower than that of triphenyl phosphate and that of combinations based on tricresyl phosphate meta and para isomers. The applicant also showed that combinations composed of said alkylated triarylphosphates also may display a lower neurotoxicity than triphenyl phosphate and combinations based on tricresyl phosphate meta and para isomers.

Thus, the present invention relates to the use of an anti-wear agent or that of a combination of anti-wear agents having reduced neurotoxicity for preparing a lubricating composition to be used in aircraft turbine engines, said anti-wear agent or said combination of anti-wear agents being selected from compounds of formula A

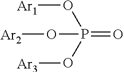

wherein Ar1, Ar2 and Ar3 represent aryl groups.

In the present application, an “aviation turbine”, an “aircraft turbine” and an “aircraft turbine engine” are intended to mean an internal combustion engine provided with an air inlet, an air compression area, at least one combustion chamber, a turbine and an air exhaust area, said engine being suitably used as an aircraft propulsion means.

An “anti-wear agent or “a combination of anti-wear agents” is equally a compound or a combination of compounds that can improve the metal wear resistance.

In some embodiments, the lubricating composition is a lubricating composition to be exclusively used for lubricating aircraft turbine engines.

In the context of the invention, an aryl group represents a group comprising a phenyl ring which is optionally substituted with one or more alkyl, aryl or aralkyl group(s). As used herein, “aryl group” also includes aryl groups condensed with another ring, preferably an aromatic ring. In the context of the invention, a combination of compounds is intended to mean a group of at least two distinct compounds. “At least 2 compounds” encompasses at least 3 compounds, at least 4 compounds, at least 5 compounds, at least 6 compounds, at least 8 compounds, at least 10 compounds. In the context of the invention, a combination of anti-wear agents of formula A is intended to mean a group of at least two distinct compounds of formula A.

As used herein, when the position of the alkyl radical(s) on phenyl or aryl groups of triarylphosphate is not indicated, it means that the alkyl radical(s) may be independently on position ortho, meta or para of the alkylated phenyl or aryl group(s). For example, di-tert-butylphenyl phenyl phosphate include the (meta, meta) isomer, the (para, para) isomer, the (ortho, ortho) isomer, the (ortho, meta) isomer, the (ortho, para) isomer and the (para, meta) isomer of di-tert-butylphenyl phenylphosphate.

For illustrative purpose, a combination comprising a total of (x) moles of two formula A compounds (i) and (ii) consists in (a) moles of compound (i) and in (x-a) moles of compound (ii).

The compounds of formula A are well known from the person skilled in the art. They may be obtained, for example, by reacting phosphoryl trichloride (also known as phosphorus oxychloride) with one or more distinct phenol compound(s) depending on the nature of their Ar1, Ar2 and Ar3 groups.

The person skilled in the art will be able, for example, to adapt the experiment protocols described in the U.S. Pat. No. 3,859,395 or in the European patent EP 1 115 728.

It should be also noted that some triaryl phosphates and their combinations are commercially available.

Preferably, the neurotoxicity of a compound or a combination of compounds is determined by measuring the BChE residual activity percentage according to an in vitro assay similar to that described in example 2 of the present application. This test comprises following steps consisting in:

(i) Adding the compound or the combination of compounds to be tested to a solution comprising hepatic microsomes in the presence of NADPH so that to obtain a total concentration of compound(s) to be tested ranging from about 0.25 μg/ml to about 25 μg/ml;

(ii) After incubation, adding butyrylcholinesterase (BChE) to the solution resulting from step (i);

(iii) After incubation, measuring the BChE residual activity of the solution resulting from step (ii) and calculating the BChE residual activity percentage, said percentage corresponding to the ratio between said BChE residual activity and the BChE activity of the reference experiment, said ratio being multiplied by 100. The reference experiment represents the control experiment carried out with no compound or combination of compounds (that is to say without adding any compound to be tested in step (i)).

In the context of the invention, a compound or a combination of compounds has a reduced neurotoxicity if the minimal BChE residual activity percentage of said compound is at least 50%.

A residual activity percentage of at least 50% means a residual activity percentage of at least 55%, at least 56%, at least 57%, at least 58%, at least 59%, at least 60%, at least 61%, at least 62%, at least 63%, at least 64%, at least 65%, at least 66%, at least 67%, at least 68%, at least 69%, at least 70%, at least 71%, at least 72%, at least 73%, at least 74%, at least 75%, at least 76%, at least 77%, at least 78%, at least 79%, at least 80%, at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, at least 99.5%.

Preferably, an anti-wear agent or a combination of anti-wear agents with a reduced neurotoxicity according to the present invention has a minimal BChE residual activity percentage of at least 65% and more preferably of at least about 70%.

As used herein, a minimal BChE residual activity for a compound refers to the lowest BChE residual activity determined in the compound concentration range from about 0.25 μg/ml to about 25 μg/ml by performing the above-described in vitro BChE activity assay. The said in vitro BChE activity assay is fully-described in the end of the present specification.

The applicant showed that the triaryl phosphates with the lowest neurotoxicity in the context of the invention (that is to say with the higher BChE residual activity percentage) are the compounds of formula A, wherein at least one of the Ar1, Ar2 and Ar3 groups is substituted with at least one alkyl group comprising at least two carbon atoms.

In the same way, the applicant showed that combinations of triaryl phosphates with a reduced neurotoxicity are combinations that are mainly composed of compounds of formula A, wherein at least one of the Ar1, Ar2 and Ar3 groups is substituted with at least one alkyl group comprising at least two carbon atoms.

Thus, in a preferred embodiment, said use is characterized in that
(i) said anti-wear agent has at least one of the Ar1, Ar2 and Ar3 aryl groups thereof substituted with at least one linear or branched alkyl radical comprising at least 2 carbon atoms or
(ii) said combination of anti-wear agents comprises at least 90% in moles of compounds of formula A, wherein at least one of the Ar1, Ar2 and Ar3 groups is substituted with at least one linear or branched alkyl radical comprising at least two carbon atoms, the mole percentage being expressed as related to the total number of moles of compounds of formula A present in said combination of anti-wear agents.

In the context of the invention, at least 90% in moles means at least 91%, at least 92%, at least 93%, at least 94%, at least 95%, at least 96%, at least 97%, at least 98%, at least 99%, at least 99.5% in moles.

Obviously, a combination of anti-wear agents according to the present invention may comprise at most 10% in moles of compounds of formula A not satisfying the condition (ii) that is to say at most 10% in moles of compounds having no alkyl substituent with at least 2 carbon atoms on their Ar1, Ar2 and Ar3 groups.

In the context of the invention, at least one alkyl group means one alkyl group or a plurality of alkyl groups.

The said anti-wear agent and the said combination of anti-wear agents preferably have a purity of at least 96%. A purity of at least 96% include a purity of at least 96.5%, of at least 97%, of at least 97.5%, at least 98%, of at least 98.5%, of at least 99%, of at least 99.5%. The purity of the anti-wear agent and that of the combination may be determined by GC-MS as described in Example 1 hereafter.

Preferably, the Ar1, Ar2 and Ar3 groups, when substituted, each comprise from 1 to 3 alkyl group(s).

The Ar1, Ar2 and Ar3 groups of the anti-wear agents according to the invention are preferably selected in the group consisting of (i) non-alkylated substituted aryl groups such as phenyl or naphtyl, (ii) aryl groups substituted with at least one methyl groups and (iii) aryl groups comprising at least one alkyl group having at least 2 carbon atoms. The selection of Ar1, Ar2 and Ar3 are performed so as to respect the rules previously cited in order to obtain an anti-wear agent or a combination of anti-wear agents having a reduced neurotoxicity.

When the triarylphosphates comprise a methyl group, the said methyl group is preferably not located on ortho position as compared to the phosphate group position.

In a preferred embodiment, the method of the invention is further characterized in that
(i) said anti-wear agent has at least two of the Ar1, Ar2 and Ar3 groups thereof each substituted with at least one linear or branched alkyl radical comprising from 2 to 12 carbon atoms, or
(ii) said anti-wear combination comprises at least 30% in moles of compounds of formula A, wherein at least two of the Ar1, Ar2 and Ar3 groups thereof are each substituted with at least one linear or branched alkyl radical comprising from 2 to 12 carbon atoms.

In the context of the invention, at least 30% in moles means at least 35%, at least 40%, at least 45%, at least 50%, at least 55%, at least 60%, at least 65%, at least 70%, at least 75%, at least 80%, at least 85% in moles.

In another preferred embodiment, the use according to the invention is further characterized in that:
(i) The Ar1, Ar2 and Ar3 groups of said anti-wear agent are each substituted with at least one linear or branched alkyl radical comprising from 2 to 12 carbon atoms, or
(ii) said combination of anti-wear agents comprises at least 30% in moles of compounds of formula A, wherein the Ar1, Ar2 and Ar3 groups are each substituted with at least one linear or branched alkyl radical comprising from 2 to 12 carbon atoms.

As previously mentioned, the remaining aryl groups of said compounds (i.e the aryl groups of said compound which do not comprise an alkyl group comprising from 2 to 12 carbon atoms) are selected in the group consisting of non-alkylated aryl groups, such as naphthyl and phenyl, and aryl groups comprising at least one methyl group on position ortho or meta.

In a particular embodiment of the method of the invention wherein said anti-wear agent is a compound of formula A having its Ar1, Ar2 and Ar3 each substituted with at least one alkyl group, said compound is characterized by:
an alkyl group average number (i.e. an average alkylation rate P) that is higher than or equal to 3. Preferably, the P value does range from 3 to 9. A P value of 9 could mean that the Ar1, Ar2 and Ar3 groups each comprise three alkyl substituents.
a number of alkyl carbons N higher than or equal to 6, preferably, higher than or equal to 9.

In a particular embodiment of the method of the invention wherein the combination of anti-wear agents comprises at least 30% in moles of compounds of formula A having their Ar1, Ar2 and Ar3 groups each substituted with at least one alkyl radical, said combination of anti-wear agents with a reduced neurotoxicity is characterized by:
an alkyl group average number per triaryl phosphate molecule (i.e. an average alkylation rate P) higher than or equal to 1.5.
a number of alkyl carbons N per triaryl phosphate molecule higher than or equal to 3, preferably higher than or equal to 4.5.

In a particular embodiment of the method of the invention, said combination of anti-wear agents comprises:

(i) from 0% to 20% in moles of compounds of formula A, said compounds having only one of their Ar1, Ar2 and Ar3 groups substituted with an alkyl radical,

(ii) from 30% to 45% in moles of compounds of formula A, each of said compounds having two of their Ar1, Ar2 and Ar3 groups each substituted with only one alkyl group, and

(iii) from 35% to 50% in moles of compounds of formula A, said compounds having the Ar1, Ar2 and Ar3 groups thereof each substituted with only one alkyl group, said alkyl groups comprising from 2 to 12 carbon atoms and said molar percentages being expressed as related to the total number of moles of compounds of formula A present in said combination of anti-wear agents.

It goes without saying in the latter embodiment that the combination of anti-wear agents does satisfy the condition according to which it comprises at least 90% in moles of compounds of formula A, said compounds having at least one of their Ar1, Ar2 and Ar3 groups substituted with at least one alkyl radical having from 2 to 12 carbon atoms.

In the hereabove mentioned embodiments, the alkyl radicals are selected from the list consisting of linear or branched ethyl, propyl, butyl, pentyl, hexyl, heptyl, octyl, nonyl, decyl, undecyl and dodecyl groups.

Preferably, the alkyl radicals are selected from the list consisting of linear or branched propyl, butyl, pentyl, hexyl, heptyl and octyl groups. Without being bound by any theory, the applicant believes that triaryl phosphates substituted with branched, preferably hindered, alkyl groups, may have a very low neurotoxicity as determined by the BChE activity assay described in Example 2.

Examples of alkyl branched groups include isopropyl, isobutyl, isopentyl, tert-butyl, tert-pentyl, neopentyl, sec-butyl, 4,4-dimethylbutyl, 5,5-dimethylpentyl, neo-hexyl and iso-octyl groups.

In a preferred embodiment, the alkyl radicals having from 2 to 12 carbon atoms are selected among branched alkyl radicals having from 3 to 5 carbon atoms such as isopropyl, isobutyl, isopentyl and neopentyl.

In the hereabove mentioned embodiments of the method of the invention, the Ar1, Ar2 and Ar3 groups of the anti-wear agent(s) representing at least 90% of the total number of moles of the anti-wear combination are selected from the group consisting of phenyl, cresyl, xylenyl, monoalkyl-phenyl groups substituted with one alkyl group comprising from 2 to 12 carbon atoms, naphthyl, napththyl groups substituted with methyl groups, and monoalkylnaphthyl groups substituted with one alkyl group having from 2 to 12 carbon atoms. When Ar1, Ar2 and/or Ar3 comprise a methyl group, the said methyl group is not on position ortho.

In a particular embodiment, the Ar1, Ar2 and Ar3 groups are selected from the group consisting of phenyl and monoalkyl-phenyl groups having one alkyl group comprising from 2 to 12 carbon atoms, preferably having from 3 to 5 carbon atoms.

For a non limitative illustration purpose only, the Ar1, Ar2 and Ar3 groups may be selected from the group consisting of phenyl, tert-butyl phenyl, isopropyl phenyl, dimethylbutyl phenyl and neopentyl phenyl.

For illustrative purpose and without wishing to be limitative, the anti-wear agent of the invention or the compounds representing 90% in moles of the anti-wear combination of the invention may be selected from tri-neopentylphenyl phosphate, tri-dimethylbutylphenyl phosphate, tri-isopropylphenyl phosphate, tri-tert-butylphenyl phosphate, di-neopentylphenyl phenyl phosphate, di-dimethylbutylphenyl phenyl phosphate, di-isopropylphenyl phenyl phosphate, di-tert-butylphenyl phenyl phosphate, neopentylphenyl diphenyl phosphate, dim ethylbutylphenyl diphenyl phosphate, isopropylphenyl diphenyl phosphate and tert-butylphenyl diphenyl phosphate, where the alkyl substituent(s) of these compounds may be indifferently either on ortho,meta- or para position.

A combination of anti-wear agents comprising the amounts of triaryl phosphates as previously described may be obtained by mixing compounds of formula A previously synthesized and isolated.

A combination of anti-wear agents comprising the hereabove mentioned amounts may be a reaction product, i.e. directly resulting from chemical synthesis, optionally followed with one or more purification step(s).

For illustrative purpose, the patent EP 1 115 728 describes the chemical synthesis preparation of compositions that are mainly composed of tert-butylphenyl diphenyl phosphate, di-tert-butylphenyl phenylphosphate and tri-tert-butylphenyl phosphate, in particular ratios, and which triphenyl phosphate content does not exceed 5% by weight of said composition total weight.

The applicant surprisingly showed that triphenyl phosphate, tri-meta-cresyl phosphate and tri-para-cresyl phosphate induce a low BChE residual activity percentage (lower than 50%) as determined by the in vitro test described in example 2, despite the absence of substituents on the ortho-position of the aryl groups. These compounds thus have a high neurotoxicity as defined in the present invention.

Therefore, in a preferred embodiment, the combinations of anti-wear agents comprise at most 10%, even more preferably, at most 5% of compounds of formula A, wherein the Ar1, Ar2 and Ar3 groups are independently selected from the group consisting of phenyl and methyl phenyl groups.

In the context of the invention, at most 5% means at most 4%, at most 3%, at most 2%, at most 1%, at most 0.5%.

It goes without saying that the combination of anti-wear agents according to the present invention may not comprise a significant amount of triarylphosphates comprising a methyl group on ortho position such as tri-ortho-cresyl phosphate. In other words, in a preferred embodiment, the molar percentage of such compounds is at most 2%, and more preferably, at most 0.5% in moles. At most 0.5% encompasses at most 0.4%, at most 0.3%, at most 0.2% at most 0.1%.

In a particular embodiment of the method of the invention, said combination of anti-wear agents with a low neurotoxicity is devoid of triarylphosphates comprising a methyl group on position ortho and devoid of triphenyl phosphate and consists in:

(i) from 0% to 30% in moles of compounds of formula A, each of which has only one of the Ar1, Ar2 and Ar3 groups thereof substituted with an alkyl radical selected from isopropyl, tert-butyl and neopentyl.

(ii) from 30% to 50% in moles of compounds of formula A, each of which has two of the Ar1, Ar2 and Ar3 groups thereof each substituted with an alkyl group selected from isopropyl, tert-butyl and neopentyl, and

(iii) from 30% to 50% in moles of compounds of formula A, wherein the Ar1, Ar2 and Ar3 groups thereof are each substituted with an alkyl group selected from isopropyl, tert-butyl and neopentyl.

Such a combination of anti-wear agents with a reduced neurotoxicity is characterized by:
an alkyl group average number per triaryl phosphate molecule (i.e. an average alkylation rate P) ranging from 1.8 to 2.5
a number of alkyl carbons N per triaryl phosphate molecule ranging from 5.4 to 25.

The Applicant also showed that the number of alkylated phenyls per molecule of triarylphosphate is a further critical parameter having an impact on the ability of triarylphosphates to induce the inhibition of BChE.

The Applicant conceived a more sensitive assay which enables to discriminate mono-alkylated triarylphosphates, di-alkylated triarylphosphates and tri-alkylated triarylphosphates based on their ability to inhibit BChE.

The said assay is described herein in Example 3. The said assay is mainly the same that described in Example 2 except that the triarylphosphate base stock solution to be tested is performed by the dilution of triarylphosphate of interest in pure ethanol. Said modification enables to perform reliable dose-effect studies.

The Applicant showed that di-alkylphenyl phenylphosphates and tri-alkylphenyl phosphates induce no significant inhibition of the BChE activity after incubation with human liver microsomes or rat liver microsomes up to 25 μg/ml. In the concentration range from 0.25 μg/ml to 25 μg/ml, the tested di-alkylphenyl phenylphosphates and tri-alkylphenyl phosphates display a residual BChE activity which is at least 70%. Such a high residual BChE activity was not observed with alkylphenyl diphenylphosphates, even in the presence of long chain alkyls. However, the minimal BChE residual activity of alkylphenyl diphenylphosphates remained significantly higher than that of triphenylphosphate and commercially available compositions comprising tricresylphosphate (such as Durad 125 and SYN-O-AD 8484).

Accordingly, in a preferred embodiment, the combination of anti-wear agents with a reduced neurotoxicity is further devoid of alkylaryl diarylphosphates i.e. compounds of Formula A having only one aryl group substituted by an alkyl group.

Thus, the invention also relates to the use of an anti-wear agent or a combination of anti-wear agents having a reduced neurotoxicity for preparing a lubricating composition to be used in aircraft turbine engines,
(a) the said anti-wear agent or each anti-wear agent of the said combination being selected from the group consisting of compounds of formula A

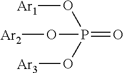

in which (i) Ar1, Ar2 and Ar3 represent aryl groups;

(ii) at least two of the said Ar1, Ar2 and Ar3 are each substituted with at least one alkyl radical and

(iii) the said alkyl radical(s) are branched groups having independently from each other, from 3 to 8 carbon atoms; and
(b) the said anti-wear agent or the said combination having a minimal residual BChE activity of at least 65% according to the in vitro BChE activity assay.

It should be noticed, that the alkyl radicals present on anti-wear agents may be distinct from each other (intra or intermolecule). In other words, an anti-wear agent according to the invention may have one type of alkyl radicals or several types of alkyl radicals.

For illustrative purpose, without being limited to, an anti-wear agent of the invention may have (i) only tert-butyl radicals or (ii) may have both tert-butyl and isopropyl radicals.

The remaining aryl groups i.e. the aryl groups which do not comprise at least one alkyl radical comprising from 3 to 8 carbon atoms are selected in the group consisting of non-alkylated aryl groups, such as naphthyl and phenyl, and aryl groups comprising at least one methyl group in position ortho or meta.

In some embodiment the remaining aryl groups are selected in the group consisting of phenyl, naphthyl and meta and para isomers of cresyl and xylenyl.

In other words, Ar1, Ar2 and Ar3 are independently selected in the group consisting of phenyl, naphthyl, meta and para isomers of xylenyl and cresyl and aryl groups comprising at least one branched alkyl radical having from 3 to 8 carbon atoms. It goes without saying that, for each compound or for each combination, Ar1, Ar2 and Ar3 are selected so that to verify the conditions previously mentioned.

For illustrative purpose, the anti-wear agent of the invention or one agent of the combination of the invention may be di-tert-butylphenyl para-cresyl phosphate or di-isopropylphenyl meta-cresyl phosphate.

In a preferred embodiment, the said anti-wear agent and the said combination of anti-wear agents have a purity of at least 96%. A purity of at least 96% include a purity of at least 96.5%, of at least 97%, of at least 97.5%, at least 98%, of at least 98.5%, of at least 99%, of at least 99.5%. The said purity may be determined by GC-MS as described in Example 1 hereafter.

In some embodiment, the said combination of anti-wear agents consists in:
(i) from 0% to 100% in moles of one or more compounds of formula A comprising two aryl groups among Art Ar2 and Ar3 each substituted independently with one alkyl radical and
(ii) from 0% to 100% in moles of compounds of formula A comprising Ar1, Ar2 and Ar3 each independently substituted with one alkyl radical,

the said alkyl groups having independently from 3 to 8 carbon atoms and the percentages being expressed as related to the total number of moles of said combination of anti-wear agents.

In other words, the said combination of anti-wear agents having a reduced neurotoxicity consists in a mixture of di-alkylaryl arylphosphates and tri-alkylaryl phosphates.

The said combination of anti-wear agents may be selected among (i) a combination of di-alkylaryl arylphosphates, (ii) a combination of tri-alkylaryl phosphates and (iii) a combination of both tri-alkylaryl phosphate(s) and di-alkylaryl arylphosphate(s).

Accordingly, when the invention is related to a single anti-wear agent, the said anti-wear agent having a reduced neurotoxicity is selected from the group consisting of di-alkylaryl arylphosphates and tri-alkylaryl phosphates.

The alkyl groups are preferably selected from the groups consisting of branched propyl, butyl, pentyl, hexyl, heptyl and octyl radicals. In other words, the alkyl groups comprise from 3 carbons to 8 carbons and are preferably branched.

Examples of appropriate branched alkyl groups having from 3 to 8 carbons include, without being limited to, isopropyl, isobutyl, isopentyl, tert-butyl, tert-pentyl, neopentyl and neohexyl.

An alkyl group having from 3 to 8 carbon atoms includes an alkyl group having 3 carbon atoms, an alkyl group, an alkyl group having 4 carbon atoms, an alkyl group having 5 carbon atoms, an alkyl group having 6 carbon atoms, an alkyl group having 7 carbon atoms and an alkyl group having 8 carbon atoms.

In a more preferred embodiment, the said alkyl groups are branched alkyl groups having from 3 to 5 carbon atoms. In this respect, said groups include isopropyl, isobutyl, isopentyl and neopentyl.

In some embodiments, as previously mentioned, the aryl groups Ar1, Ar2 and Ar3 are selected from the group of phenyl and mono-alkyl phenyl groups.

In other embodiments, the said anti-wear agent or the said combination of anti-wear agents are selected from the group consisting of tri-neopentylphenyl phosphate, tri-dimethylbutylphenyl phosphate, tri-isopropylphenyl phosphate, tri-tert-butylphenyl phosphate, di-neopentylphenyl phenyl phosphate, di-dimethylbutylphenyl phenyl phosphate, di-isopropylphenyl phenyl phosphate and di-tert-butylphenyl phenyl phosphate.

In some embodiments, the said anti-wear agent is selected from the group of tri-isopropylphenyl phosphate, tri-tert-butylphenyl phosphate, di-isopropylphenyl phenylphosphate and di-tert-butylphenyl phenylphosphate, the alkyl groups of said compounds being indifferently on position meta, para or ortho.

In some embodiments the said combination of anti-wear agents having a reduced neurotoxicity consists in a mixture of compounds selected from the group consisting of tri-isopropylphenyl phosphate, tri-tert-butylphenyl phosphate, di-isopropylphenyl phenylphosphate and di-tert-butylphenyl phenylphosphate. In other words, the said combination of anti-wear agents with reduced neurotoxicity consists in:

(i) from 0% to 100% in moles of compounds of formula A selected from tri-isopropylphenyl phosphate and tri-tert-butylphenyl phosphate (ii) from 0% to 100% in moles of compounds of formula A selected from di-isopropylphenyl phenylphosphate and di-tert-butylphenyl phenylphosphate.

the percentages being expressed as related to the total number of moles of said combination of anti-wear agents.

In some other embodiments, the combination of anti-wear agents is selected from:
(a) a combination of tri-tert-butylphenyl phosphate and di-tert-butylphenyl phenylphosphate
(b) a combination of tri-isopropylphenyl phosphate and di-isopropylphenyl phenylphosphate
(c) a combination of tri-tert-butylphenyl hosphate and tri-isopropylphenyl phosphate
(d) a combination of tri-tert-butylphenyl phosphate and di-isopropylphenyl phenylphosphate
(e) a combination of di-tert-butylphenyl phenylphosphate and tri-isopropylphenylphosphate and
(f) a combination of di-tert-butylphenyl phenylphosphate and di-isopropylphenyl phenylphosphate.

The Applicant showed that in the case of di-alkylphenyl phenylphosphate and tri-alkylphenylphosphate, the positions of alkyl groups (meta, para and ortho) may not have a significant impact on the ability of said compounds to inhibit human plasma BChE activity. Such a fact was clearly established for tri-tert-butylphenyl phosphate isomers.

Consequently, the anti-wear agents may comprise alkyl substitutions on position para, ortho or meta of their phenyl or aryl groups.

In some embodiments, the antiwear-agents may comprise alkyl groups on position para.

Depending on the anti-wear agent or the combination of anti-wear agents with a reduced neurotoxicity that is used, the applicant surprisingly showed that the adding of a very small amount of a complementary anti-wear agent more active than the triarylphosphates but having a low thermal stability may synergically act with triarylphosphate by significantly improving the load carrying capacity without impairing the other properties of the resulting lubricating composition (in particular its physico-chemical stability and deposit forming tendency).

As used herein, a “complementary anti-wear agent having low thermal stability is intended to mean an anti-wear agent which becomes unstable at temperatures over 180° C. and which has a high anti-wear activity, preferably higher than that of cresyl phosphates. Such a “complementary anti-wear agent having low thermal stability” is generally not recommended to be used in lubricating compositions for aircraft turbine engines.

The anti-wear activity of a complementary anti-wear agent may be simply measured using the 4-ball test according to ASTM 2266. The most active anti-wear additives are those which reduce the wear diameter at a lower treatment rate as compared to tricresyl phosphates.

The complementary anti-wear agent is added in an amount ranging from 0.005% to 0.3% by weight, the percentage being expressed as related to the lubricating composition total weight. Such a low percentage allows a significant improvement of the load carrying capacity resistance (WAM) (a value that may reach 20, or even may exceed 20, depending on the measurement method described in the AIR 4978 standard).

Thus, in a particular embodiment, said method of the invention is further characterized in that the lubricating composition for aircraft turbines comprises from 0.005% to 0.3% by weight of a complementary anti-wear additive.

Preferably, the lubricating composition for aircraft turbines comprises from 0.01% to 0.08% by weight of a complementary anti-wear additive.

Such additives are well known from the person skilled in the art. The said complementary anti-wear additive encompasses, without being limited to, organosulfur compounds such as disulfides, mercaptans, thioacids and thioesters and organophosphorous compounds such as thiophosphates, thiophosphites, amine phosphates, alkyl phosphites or tri-alkylphosphates.

Accordingly, complementary anti-wear additives include mercaptobenzothiazole, thiobenzoic acid, sulfurized oleic acid, triphenyl phosphorothionate (marketed by the Ciba-Geigy company under the trade name “Irgalube TPPT”), mono or di-phosphoric acid amine salt such as Vanlube 692 marketed by the RT Vanderbilt company, this list being not limitative.

Anti-wear agents and the combinations of anti-wear agents with a reduced neurotoxicity according to the present invention offer additional technical advantages over traditional anti-wear agents, especially over triphenyl phosphate and tricresyl phosphates. Anti-wear agents and the combinations of anti-wear agents according to the present invention do especially have a lower volatility.

It is expected from their low volatility that it enables the anti-wear activity of the lubricating composition into which they are incorporated to less rapidly decrease when said lubricating composition undergoes elevated temperatures.

The present invention also provides a lubricating composition for aircraft turbines characterized in that it comprises an anti-wear agent or a combination of anti-wear agents with a reduced neurotoxicity such as described in various hereabove detailed embodiments.

Said lubricating composition comprises at least 90% by weight of one or more long-chain ester(s) and an amount of anti-wear agents with a reduced neurotoxicity according to the present invention ranging from 1% to 5% by weight, as related to the composition total weight.

As used herein, a “long chain” is intended to mean a linear or a branched hydrocarbon chain comprising from 4 to 20 carbon atoms. The long chain of a long-chain ester does not comprise the carbon atom of the ester function.

In the context of the invention, a “long-chain ester” or a “synthetic long-chain ester” is intended to mean the reaction product of a long-chain carboxylic acid with an alcohol, which alcohol may be a polyol. Therefore, long-chain esters include long-chain mono-, di-, tri-, tetra-, penta- and hexa-esters, this list being not limitative. Long-chain esters may comprise one or more hydrocarbon long chain(s).

Said lubricating combination may further comprise one or more additional additive(s), such as antioxidants, anticorrosive agents, yellow metal deactivators, detergents, foam inhibitors, hydrolysis stabilizers, or viscosity modifying agents, this list being not limitative. Such additional additives account for 5% to 9% of the total weight of said lubricating composition. Moreover, they are well known from the person skilled in the art and generally commercially available. However, one should avoid the use of halogenated additives which are less stable at very high temperatures and that of metal salts or complexes, especially zinc salts or zinc-based complexes, which may damage the metal parts to be lubricated.

In a particular embodiment, said lubricating composition for aircraft turbine engine is characterized in that it consists in:
(a) at least 90% by weight of one or more long-chain ester(s),
(b) from 1% to 5% by weight of one or more antioxidant(s),
(c) from 1% to 5% by weight of an anti-wear agent or a combination of anti-wear agents with a reduced neurotoxicity such as described in the present application,
(d) from 0.01% to 0.3% of one or more anti-corrosion and/or yellow metal deactivating additive(s),

the percentages by weight being related to total weight of the lubricating composition.

Advantageously, the long-chain ester(s) is or are selected from the group consisting of the reaction products of one or more polyol(s) with one or more carboxylic acid(s) with 4 to 12 carbon atoms, where the hydrocarbon chains of said carboxylic acids may be linear or branched.

For a non limitative illustration purpose only, polyols appropriate for obtaining esters suitable for use in lubricating compositions of aircraft turbines include trimethylol propane, pentaerythritol, dipentaerythritol, neopentylglycol, tripentaerythritol, ditrimethylol propane and their mixtures.

For a non limitative illustration purpose only, carboxylic acids appropriate for obtaining esters suitable for use in lubricating compositions of aircraft turbines include valeric acid, isovaleric acid, heptanoic acid, caprylic acid, nonanoic acid, isononanoic acid, 2-ethyl hexanoic acid and capric acid.

Thus, the long-chain ester(s) of said lubricating composition may be selected from products resulting from the reaction of pentaerythritol and dipentaerythritol with one or more carboxylic acid(s) selected from the group consisting of valeric acid, isovaleric acid, heptanoic acid, caprylic acid, nonanoic acid, isononanoic acid, 2-ethyl hexanoic acid and capric acid.

For a non limitative illustration purpose only, long-chain esters may be prepared by reacting a commercially available technical pentaerythritol with a mixture of carboxylic acids having 4 to 12 carbon atoms under standard esterification conditions that are well known from the person skilled in the art. Technical pentaerythritol is a mixture comprising from about 85% to 92% by weight of monopentaerythritol and from 8% to 15% by weight of dipentaerythritol. It may further comprise some amount of tri- and tetra-pentaerythritol which are traditionally formed as by-products during the preparation of technical pentaerythritol.

The synthetic ester composition marketed by NYCO under reference Nycobase 5750 is a suitable example of a combination of esters that could be suitably used for the lubricating composition of the invention.

The antioxidant(s) in the lubricating composition of the invention may be selected from compounds well known from the person skilled in the art such as aromatic amines, aromatic amine oligomers, mercaptans such as thiodipropionic acid esters, alkyl sulfates, phenol derivatives substituted with hindered alkyl groups, trialkyl phosphites, triaryl phosphites and their mixtures, this list being not limitative.

In a preferred embodiment, the antioxidant(s) is or are selected from aromatic amines and, especially, from diaryl amines, N-aryl naphthyl amines, homo- and hetero-oligomers thereof, and their mixtures. Aromatic rings of diaryl amines, N-aryl naphthyl amines and oligomers thereof may be optionally substituted with one or more alkyl group(s) comprising from 2 to 10 carbon atoms.

The person skilled in the art could for example refer to the application WO 95/16765, which discloses the preparation of an anti-oxidizing composition comprising diaryl amine oligomers as well as diaryl amine/N-aryl naphthyl amine heterodimers, or to the U.S. Pat. No. 5,489,711 which discloses the preparation of diaryl amine oligomers possessing anti-oxidizing properties.

For a non limitative illustration purpose only, particularly preferred antioxidants include di(octylphenyl)amines, octylphenyl-a-naphthyl amines and their oligomers.

The one or more anti-corrosion and/or yellow metal deactivating additive(s) is or are selected from agents that are well known from the man skilled in the art, especially from benzotriazole derivatives.

For a non limitative illustration purpose only, particularly preferred additives include benzotriazole and methyl benzotriazole.

In a particular embodiment, said lubricating composition is characterized in that:
(i) the long-chain ester(s) is or are selected from products resulting from the reaction of pentaerythritol and dipentaerythritol with one or more carboxylic acid(s) selected from the group consisting of valeric acid, isovaleric acid, heptanoic acid, caprylic acid, nonanoic acid, isononanoic acid and capric acid,
(ii) the antioxidant(s) is or are selected from diphenyl amines, phenyl-a-naphthyl amines and their oligomers, these compounds being optionally substituted with one or more alkyl group(s) having from 2 to 10 carbon atoms,
(iii) the anti-corrosion and/or yellow metal deactivating additive(s) is or are selected from benzotriazole and methyl benzotriazole and;
(iv) (a) When the said lubricating composition comprising an anti-wear agent with reduced neurotoxicity, the said anti-wear agent is selected from the group of di-alkylaryl arylphosphates and tri-alkylaryl phosphates, and
(b) When the said lubricating composition comprising a combination of anti-wear agents having reduced neurotoxicity, the said combination consists in a mixture of di-alkylaryl arylphosphates and tri-alkylaryl phosphates.

The said lubricating composition may be further characterized in that the anti-wear agent or the compounds of the anti-wear combination having a reduced neurotoxicity are selected from the group of tri-isopropylphenyl phosphate, tri-tert-butylphenyl phosphate, di-isopropylphenyl phenylphosphate and di-tert-butylphenyl phenylphosphate. In a preferred embodiment, the lubricating composition is an aircraft turbine engine lubricating composition.

Depending on the anti-wear agent or the combination of anti-wear agents with reduced neurotoxicity that is used, the applicant showed that it is possible to improve the load carrying capacity of the lubricating composition by adding a very small amount of a complementary anti-wear additive having a low thermal stability, that is to say traditionally not recommended for lubricating aircraft turbines, but having a better anti-wear activity than triaryl phosphates.

Thus, in a particular embodiment, said lubricating composition for aircraft turbines is further characterized in that it comprises from 0.005% to 0.3% by weight of a complementary anti-wear additive having low thermal stability.

Preferably, the lubricating composition for aircraft turbines comprises from 0.01% to 0.08% by weight of a complementary anti-wear additive having low thermal stability.

Such additives are well known from the person skilled in the art and include, without being limited to, organosulfur compounds, such as disulfides, mercaptans, thioacids and thioesters, thiophosphates, thiophosphites, amine phosphates, dialkyl phosphites and tri-alkyl phosphates.

A lubricating composition of the invention, due to the presence of the anti-wear agent and of the combination of anti-wear agents defined in the present specification is characterized by a WAM bearing wear value, as measured by the SAE AIR 4978 test method higher than 15 or even higher than 20.

Moreover it is expected that said composition has a lower neurotoxicity, especially, as compared to lubricating compositions comprising as anti-wear agents triphenyl phosphate and/or tricresyl phosphates. It is further expected that the lubricating compositions of the invention have an extended lifetime because of the lower volatility of the reduced neurotoxicity anti-wear agents that are used.

Generally speaking, the lubricating compositions of the invention have physico-chemical properties enabling their use in aircraft turbines, i.e.:
a chemical stability within a broad temperature range typically ranging from −50° C. to +250° C.,
An oxidation stability and a coking resistance at use temperatures (180-250° C).

The lubricating compositions of the invention generally satisfy the main characteristics defined by the MIL-PRF-23699 standard of the US NAVY as well as the AS 5780 standard of the SAE (Society of Automotive Engineer) for aircraft turbine lubricating oils.

It is a further object of the invention to provide a method for preparing an aircraft turbine engine lubricating composition such as previously described, said method comprising the steps consisting in:
(i) providing an anti-wear agent or a combination of anti-wear agents having reduced neurotoxicity as defined above,
(ii) adding the anti-wear agent or the said combination of anti-wear agents to one or more compounds selected from long chain esters, anti-oxidant agents and anti-corrosion agents and
(iii) obtaining the lubricating composition for aircraft engine turbines.

The anti-wear agent and the combination of anti-wear agents with a reduced neurotoxicity are those described in the present specification.

The lubricating composition obtained by the said method may further comprise one or more additive(s), said additive(s) enabling (i) either to improve the lubricating composition physico-chemical properties, or (ii) to protect the mechanisms to be lubricated from any possible damage.

In a preferred embodiment, said method comprises one or more additional step(s) following or prior to the step of adding the anti-wear agent or the combination of anti-wear agents, said additional step(s) consisting in adding one or more additive(s) to the ester composition.

These additives are preferably selected from antioxidants, anticorrosive agents, yellow metal deactivators, and agents for improving the load carrying capacity.

As previously mentioned, the neurotoxicity of anti-wear agents and combinations thereof is preferably determined by an in vitro BChE activity assay.

For reminder, the said assay comprises the steps of:

(i) Adding the compound or the combination of compounds to be tested to a solution comprising hepatic microsomes in the presence of NADPH so that to obtain a total concentration of compound(s) to be tested ranging from about 1 μg/ml to about 25 μg/ml;

(ii) After incubation of the solution provided in step (i), adding butyrylcholinesterase (BChE) to the solution resulting from step (i);

(iii) After incubation of the solution provided in step (ii), measuring the BChE residual activity of the solution resulting from step (ii) and calculating the BChE residual activity percentage, said percentage corresponding to the ratio between said BChE residual activity and the BChE activity of the reference experiment, said ratio being multiplied by 100. The reference experiment represents the control experiment carried out with no compound or combination of compounds (that is to say without adding any compound to be tested in step (i)).

The BChE is preferably a purified human BChE which may be recombinant or non-recombinant i.e. obtained from human plasma.

The hepatic microsomes may be selected from human liver microsomes or rat human microsomes. In a preferred embodiment, the hepatic microsomes are human liver microsomes. The said microsomes may be obtained as described in Paine et al, 1997, J. Pharmacol. Exp. Ther. 283 (3), pp. 1552-1562.

The one skilled in the art can determine by routine experiments the better experimental conditions to perform the above-mentioned in vitro assay.

For example, in some embodiments, the amount of microsomes to be used in step (i) may be sufficient to provide about 0.25 pg/ml to about 0.65 pg/ml of cytochrome P450. The concentration of NADPH in step (i) may be from 0.5 mM to 1.5 mM depending on the amount of microsomes. An appropriate concentration of NADPH may be about 1 mM.

The base stock solution of the compound to be tested may be prepared in phosphate buffer or in ethanol solution, depending on its solubility. When ethanol is used to dissolve or dilute the compound to be tested, the ethanol amount in the solution obtained in step (i) is from about 0.1% to about 1.5% per volume. An appropriate percentage of ethanol may be about 1% (v/v).

For example, the compound to be tested (or the combination to be tested) is dissolved in pure ethanol in a concentration about 2.5 mg/ml. The said base-stock is then diluted in water/ethanol mixture to provide dilution solutions having a compound concentration from about 10 μg/ml to about 250 μg/ml and a percentage of ethanol of about 10% (v/v).

The incubation of the solution provided in step (i) may be carried out at room temperature (i.e. about 25° C.) from about 20 min to 1 hour.

In step (ii), the concentration of BChE may range from about 0.2 μg/ml to about 1.2 μg/ml. The incubation of the solution provided in step (ii) may be carried out at room temperature (i.e. about 25° C.) during from 20 min to 1 hour.

The measurement of the BChE residual activity in step (iii) is preferably carried out using the method of Ellman et al. (Ellman et al., 1961. Biochem Pharmacol 7: 88-95). The one skilled in the art can easily adapt, if necessary, the said method in order to measure the residual BChE activity from solutions obtained in step (iii), by routine experiments. For example, the one skilled in the art may use the experimental conditions described in the Example 2 of the present specification.

The present invention will be now illustrated, without being limited to, by means of the following examples.

### EXAMPLES

### Example 1

### Synthesis and Characterization of Triaryl Phosphates and Combinations Thereof

### a. Synthesis and Characterization of Triaryl-Phosphates

Table 1 hereunder displays the products that have been synthesized in the context of the present study.

TABLE 1
Synthesized product

| N^{o} | Product name |
|---|---|
| P1 | Tri-para-tert-butylphenyl phosphate |
| P2 | Tri-para-isopropylphenyl phosphate |
| P3 | Tri-ortho-isopropylphenyl phosphate |

The synthesis method that is used relies upon the reaction consisting in reacting phosphorus oxichloride with an appropriate phenol compound or with a mixture of appropriate phenols, depending on the final product expected.

A tri(4-tert-butylphenyl)phosphate (compound P1) synthesis method is described hereafter for illustrative purpose.

Tri(4-tert-butylphenyl) phosphate synthesis

In a 250 ml flask, 15 g of 4-tert-butyl phenol (MW 150.22, 0.1 mole), 50 ml of heptane and 5 g of phosphorus oxychloride (MW 150.33, 0.03 mole) are introduced. The mixture is stirred at 20° C. and 10-12 g of triethyl amine (0.1-0.12 mole) are gradually added thereto. The mixture is heated under gentle reflux for 48-72 h. The mixture is allowed to cool to room temperature and the resulting suspension is filtered so as to remove the triethyl amine hydrochloride precipitate and to recover the filtrate. The filtrate obtained is washed with water (3×10 ml). The filtrate is then concentrated under vacuum. The residue obtained is recrystallized twice in MeOH. After recrystallization, about 9 g of the desired product is obtained with a purity of 99.8% (as determined by the gas chromatography test method described in paragraph b. hereafter).

The synthesis protocol given hereabove can be easily adapted to the synthesis of the P2 and P3 compounds.

Table 2 hereafter shows for each P1, P2 and P3 compound the amounts of the reactants used for the synthesis thereof, as well as the yield and the purity of the resulting final product.

TABLE 2
Experiment conditions and results obtained. The final
product purity is determined by a GC-MS test method (gas
chromatography coupled with mass spectrometry) as described
hereafter in paragraph b.

| N^{o} | Reactants and number of moles | Purity |
|---|---|---|
| P1 | 3.0 moles of t-butyl phenol 99% + 1 mole of | 99% |
| | phosphoryl chloride | |
| P2 | 3 moles of p-isopropyl phenol + 1 mole of | 98% |
| | phosphoryl chloride | |
| P3 | 3 moles of o-isopropyl phenol + 1 mole of | 98% |
| | phosphoryl chloride | |

### b. Characterization of the Resulting Products and the Commercial Compositions Used

Table 3 hereafter shows the evaluated commercial combinations of the triaryl phosphates.

TABLE 3
commercial combinations of triaryl phosphates tested

| N^{o} | Product name | Supplier |
|---|---|---|
| C1 | Durad 300 | CHEMTURA |
| C2 | Durad 620B | CHEMTURA |
| C3 | Durad 125 | CHEMTURA |
| C4 | Durad 150B | CHEMTURA |
| C5 | Durad 150 | CHEMTURA |
| C6 | 98% tri-ortho-cresyl phosphate | City Chemical |
| C7 | 99% tri-phenylphosphate | Aldrich |
| C8 | Syn-O-Add 8484 | ICL SUPRESTA |
| C9 | Syn-O-Add-8478 | ICL SUPRESTA |

The composition of these commercial products was determined by a gas chromatography analysis on an Agilent HP 5988 HR—GC/MS chromatograph, provided with a 60 meter-long CP VOLAMINE—VARIAN column (0.32 mm internal diameter, 0.45 μm film thickness).

The analysis parameters used are as follows:
Initial oven temperature: 265° C.
Final oven temperature: 265° C.
Isothermal stage: 300 min
Injector temperature: 295° C.
Sensor temperature: 295° C.
Carrier gas flow rate (hydrogen): 15 ml/min at 4 psi

The results obtained with the previous test method were confirmed by analyzing, via GC-MS on the same apparatus, the product obtained by alkaline hydrolysis (NaOH) of the triaryl phosphate commercial combinations (more precisely by analyzing the alkyl phenol compounds released during hydrolysis).

The procedure used for such analysis is detailed hereafter:

### Triaryl Phosphate Hydrolysis Protocol

In a 100 ml-stoppered flask, 5 g of aryl phosphate (or a triaryl phosphate-based combination), 2.5 g of sodium hydroxide and 20 g of water are introduced. The reaction medium obtained is put under stirring and heated under reflux for 3 hours. A total solubilization can be observed within a 15-20 min-heating time. The reaction medium is then allowed to cool down at room temperature, thereafter is neutralized to pH 3-3.5 by adding thereto a 36-36.5% HCl solution (about 12.5 g).

Alkyl phenols are then extracted with ethyl acetate (2×15 ml). The organic phase obtained—which comprises said alkyl phenols—is dried overnight on magnesium sulfate, then filtered on folded paper-type filter.

### Phenol Compound GC-MS Analysis:

Initial oven temperature: 60° C.
Initial oven temperature stage: 7 min
Temperature programming: 5.0° C./min
Final oven temperature: 260° C.
Final oven temperature stage: 35 min
Injector temperature: 190° C.
Sensor temperature: 265° C.
Carrier gas flow rate (hydrogen): 15.4 ml/min at 4 psi

Both hereabove test methods produced similar results. The composition of the triaryl phosphate commercial combinations is determined by these test methods is given in Table 4 hereafter:

TABLE 4
GC-MS analysis of the composition of the
commercial combinations obtained.

| N^{o} | Composition (percentage in moles) |
|---|---|
| C1 | 4% of triphenyl phosphate |
| | 15.5% of isopropylphenyl diphenyl phosphate |
| | 37.5% of di-isopropylphenyl phenyl phosphate |
| | 43% of tri-isopropylphenyl phosphate |
| C2 | 2% of triphenyl phosphate |
| | 17% of tert-butylphenyl diphenyl phosphate |
| | 38% of di-tert-butylphenyl phenyl phosphate |
| | 43% of tri-tert-butylphenyl phosphate |
| C3 | 100% of tri-cresyl phosphate (isomers resulting from the |
| | reaction of phosphoryl chloride with a mixture comprising |
| | 68.6% of meta-cresol and 31.4% of para-cresol) and less |
| | than 0.1% of ortho-cresol |
| C4 | 32% of triphenyl phosphate |
| | 47% of tert-butylphenyl diphenyl phosphate |
| | 20% of di-tert-butylphenyl phenyl phosphate |
| C5 | 25% of triphenyl phosphate |
| | 48% of isopropylphenyl diphenyl phosphate |
| | 25% of di-isopropylphenyl phenyl phosphate |
| C8 | 100% of tri-cresyl phosphate isomers resulting from the reaction of |
| | phosphoryl chloride with a mixture comprising 69% of meta-cresol |
| | and 30% of para-cresol, about 1% of xylenol mixed isomers, and less |
| | than 0.1% of ortho-cresol |
| C9 | 32% of triphenyl phosphate |
| | 43% of tert-butylphenyl diphenylphosphate isomers |
| | 22% of di-tert-butylphenyl phenylphosphate isomers |
| | 3% tri-tert-butylphenyl phosphate isomers |

The C1 and C2 compositions correspond to the combinations of anti-wear agents of the invention.

The C3 to C9 compositions correspond to the control compositions as they have a high percentage of triphenyl phosphate, monoalkylphenyl diphenylphosphate or tricresyl phosphate.

For each commercial combination, the average alkylation rate p of the phenyl groups (that is to say the average number of alkyl substituents that are present per phenyl group) may be determined, as well as the average number N of alkyl carbons per triaryl phosphate molecule. These parameters are given in Table 5 hereafter.

TABLE 5
Average alkylation rate p of the phenyl groups, average
alkylation rate P per triaryl phosphate molecule and average
number N of alkyl carbons per triaryl phosphate molecule

| Reference | Product | Substituent | p | P | N |
|---|---|---|---|---|---|
| C1 | Durad 300 | iPr | 0.7 | 2.2 | 6.6 |
| C2 | Durad 620B | t-Bu | 0.7 | 2.2 | 8.9 |
| C3 | Durad 125 | Me | 1.0 | 3.0 | 3.0 |
| C4 | Durad 150B | t-Bu | 0.3 | 0.9 | 3.5 |
| C5 | Durad 150 | iPr | 0.3 | 1.0 | 3.1 |

### Example 2

### Evaluation of the Triaryl Phosphate Neurotoxicity and of Combinations Thereof

The organophosphorous compound neurotoxicity results essentially from their ability to induce the inhibition of the acetylcholinesterase of the neuronal synapses.

As part of the study, the neurotoxicity of triaryl phosphates and combinations thereof was evaluated through an in vitro test using a model enzyme of esterase: the human butyrylcholinesterase. The human butyrylcholinesterase (BChE), or plasma cholinesterase, has an enzyme activity profile close to that of human acetylcholinesterase.

In this assay, triarylphosphates of interest are first incubated with human liver microsomes in the presence of NADPH to enable the production of potential metabolites. The incubation with microsomes is then followed by incubation with purified human BChE in the context of a micro-BChE activity assay.

This in vitro assay thus reproduces the in vivo metabolization of triaryl phosphates in the liver and enables to evaluate the anti-esterase activity of the resulting metabolites.

a. Experiment Protocol

The experiment protocol hereunder has been carried out in the University of Washington (Seattle, USA), Department of Human Genetics supervised by Professor Clement Furlong.

Human liver microsome samples were collected from the Liver bank of the University of Washington. The samples correspond to non-selected livers for graft or to tissue wastes resulting from liver transplantations in child population. The liver tissue collection procedure was assented by the ad hoc ethics review committee of the University of Washington.

Liver microsome suspensions were prepared according to known protocols (Paine and al, 1997, J. Pharmacol. Exp. Ther. 283 (1997) (3), pp. 1552-1562) and stored at −80° C.

Six individual preparations of the same amount were collected to form a homogeneous pool representing the variability amongst the individuals, using a Potter-Elvehem Glass-Teflon homogenizer, with a 5 run-procedure in ice.

Mixture samples of 1.7 ml were collected in polypropylene centrifuge tubes, and thereafter stored at −80° C. The measured liver microsome content was 7.83 mg/ml.

A 250 μg/ml triaryl phosphate solution was prepared in a 50 mM sodium phosphate buffer at pH 7.4 by vigorously stirring in a vortex mixer for one minute.

The biological conversion is then initiated by adding 180 μl of the microsome preparation (comprising about 90 picograms of proteins CYP450) and 2 μl of a 0.1 mol/l NADPH solution in the 50 mM sodium phosphate buffer into 20 μl of the triaryl phosphate solution. The triaryl phosphate final concentration is 25 μg/ml.

The samples are thereafter incubated at 23° C. for one hour during the bioconversion process. This bioconversion process corresponds to the triaryl phosphate metabolization effected by the liver microsomes. Such a bioconversion process is NADPH-dependent and implies microsomal cytochromes P450 (CYP450).

Each sample is prepared in triplicate.

Negative controls are incubated under similar conditions with no NADPH, said NADPH being a cofactor that is crucial for the enzymatic activity of CYP450 from liver microsomes. These negative controls enable to verify that (i) non- metabolized triaryl phosphates do not significantly inhibit BChE activity and that (ii) the metabolites which result from the microsome-induced conversion of the triaryl phosphates are responsible for the observed inhibition of BChE activity.

To 36 μl of the triaryl phosphate/liver microsome samples prepared hereabove are added 4 μl of purified BChE at a concentration of 3.9 μg/ml. The resulting BChE-enriched aryl-phosphate/microsome solutions are incubated for one hour at room temperature.

The BChE activity is then measured according to the protocol defined by Ellman and al, (Ellman and al., 1961, Biochem Pharmacol, 7: 88-95), modified for use in micro-titration format.

For measuring the BChE activity, the samples are first diluted by adding 360 μl of a sodium phosphate buffer at pH 8.0. Then, 100 μl of each diluted sample are added to a well (in triplicate) of a 96-well microtiter plate.

The reaction is initiated by adding 100 μl of a solution comprising 0.64 mM dithionitrobenzoate (DTNB), 2.0 mM butyrylthiocholine in a sodium phosphate buffer at pH 8.0.

The BChE-induced butyrylcholine conversion is indirectly monitored by controlling the

DTNB conversion to 5-thio-2-nitrobenzoic acid (TNB). Monitoring the TNB formation is effected by measuring the absorbance at 405 nm for 4 minutes at 23° C. with a microplate optical reader such as SpectraMax Plus spectrophotometer.

The BChE residual activity in the presence of triaryl phosphate is then expressed depending on the BChE reference activity, that is to say depending on the BChE activity measured in the presence of liver microsomes and NADPH and in the absence of triaryl phosphate (reference experiment).

The control activity in that case is measured at 128+/−14 mOD/min i.e. 3.76 nmol/min according to the Beer law, for a extinction coefficient of 13.6 mM/cm for TNB and a optical path of 0.5 cm.

A compound or a combination of compounds is considered as having a low toxicity if its BChE residual activity percentage is higher than 50%, preferably higher thanabout 70%.

### REFERENCES

Ellman G L, Callaway E. 1961. Erythrocyte cholinesterase levels in mental patients. Nature 192: 1216-1217.
Ellman G L, Courtney K D, Andres V J, Feather-Stone R M. 1961. A new and rapid colorimetric determination of acetylcholinesterase activity. Biochem Pharmacol 7: 88-95.
M. F. Paine, M. Khalighi, J. M. Fisher, D. D. Shen, K. L. Kunze and C. L. Marsh and al., Characterization of interintestinal and intraintestinal variations in human CYP3A-dependent metabolism, J. Pharmacol. Exp. Ther. 283 (1997) (3), pp. 1552-1562.

b. Results

Negative controls show that no BChE inhibition could be measured in the absence of NADPH, which proves that the BChE inhibition results from the liver microsome CYP450 bioactivity and, especially, from the bioactivity of the products derived from the triaryl phosphate CYP450-induced metabolization. It should be noted that non metabolized triaryl phosphates do not have any significant butyrylcholine-esterase inhibiting activity.

On the other hand, in the presence of NADPH and triarylphosphates, BChE residual activity may significantly decrease.

Table 6 hereafter shows the results obtained for various triaryl phosphate-based commercial products.

TABLE 6
Results of the BChE residual activity measurement for triaryl
phosphate-based commercial products. These results were
obtained with a BChE reference activity of 3.76 nmol of
DTNB/min, as determined according to the previously
described test method.

| | | | BChE residual activity |
|---|---|---|---|
| | Commercial product | Batch N^{o} | percentage |
| C1 | Durad 300 | E08-021 | 75.4 +/− 10.0 |
| C2 | Durad 620B | E07-209 | 85.6 +/− 5.4 |
| C3 | Durad 125 | E07-164 | 23.3 +/− 1.3 |
| C4 | Durad 150B | E08-459 | 23.3 +/− 4.6 |
| C5 | Durad 150 | E07-163 | 21.2 +/− 1.7 |
| C6 | Triphenyl phosphate | E07-165 | 44.8 +/− 10.4 |
| C7 | Tri-(o-cresyl) phosphate | TOCP | 0.4 +/− 0.0 |

BChE residual activity percentages were obtained with a BChE reference activity of 3.76 nmol de DTNB/min, said activity being measured according to the previous test method, in the presence of liver microsomes and NADPH and in the absence of triaryl phosphate compounds.

As expected, the BChE residual activity percentage for tri-ortho-cresyl phosphate is very low, which demonstrates quasi-total inhibition of the BChE.

Triphenyl phosphate, which is totally devoid of substituent and therefore should not inhibit BChE according to the mechanism demonstrated by Casida, has nevertheless a non negligible inhibiting potential.

In the same way, Durad 125 (C3) which is exclusively composed of tricresyl phosphate para- and meta-isomers, does possess after incubation a non negligible BChE inhibiting potential.

It results therefrom that the lubricating compositions for aircraft turbines formulated at the present time with Durad 125 are not absolutely safe for the human health if fumes are inhaled because of a lack of tightness in the aircraft turbines, the air coming from the compressor being used for conditioning the air within the cabin and the cockpit.

The triphenyl phosphate combinations having a low iso-propyl and t-butyl content and a high triphenyl phosphate percentage (C4 and C5) induce a residual activity for BChE similar to that observed for the C3 combination (Durad 125).

On the contrary, the BChE residual activity in the presence of the C1 and C2 combinations, which have a high alkylation rate (p>0.5) and sterically strongly hindered alkyl groups (N>7), is substantially higher than the BChE residual activity obtained with the C3, C4 and C5 compositions.

Without being bound by any theory, the applicant think that the metabolites triaryl phosphates alkylated with hindered groups have less affinity for BChE and/or that triaryl phosphates alkylated with hindered groups are less easily metabolized by the cytochromes P450.

These experiment results were confirmed by evaluating the P1, P2 and P3 model compounds obtained according to the procedure described in example 1 with another batch of liver microsomes. These results show that triaryl phosphates tri-substituted with hindered alkyl groups produce a very low BChE inhibition (the residual activity may be higher than 90% and even 95%).

The hereabove results bring to light that triaryl phosphates strongly alkylated with hindered groups have a low neurotoxicity. The same applies for combinations essentially composed of these compounds.

### Example 3

### Additional Evaluations of Triarylphosphates

a. Methodology

A more sensitive assay was used in order to discriminate alkylphenyl diphenyl phosphates, di-alkylphenyl phenyl phosphates and tri-alkylphenyl phosphates based on their potential ability to inhibit BChE.

The assay was essentially the same as that described in Example 2 except that the triaryl phosphate solution to be tested was prepared in pure ethanol instead of in sodium phosphate buffer. Such a modification enabled to increase the sensitivity of the assay for more than one order of magnitude, because of the improved dispersion/solubilization obtained with the ethanol stock.

Some experiments were performed with rat liver microsomes (RLM) because human liver microsomes (HLM) were not available in sufficient quantity. However, human butyrylcholine esterase was used in all assays.

For a given compound, the results in terms of BChE inhibition obtained in the presence of RLM are similar to that of HLM. However, it should be noticed that, in general, the BChE inhibition levels observed in the presence RLM are higher than those observed in the presence of HLM. This fact certainly results from the higher enzymatic activity of RLM as compared to HLM.

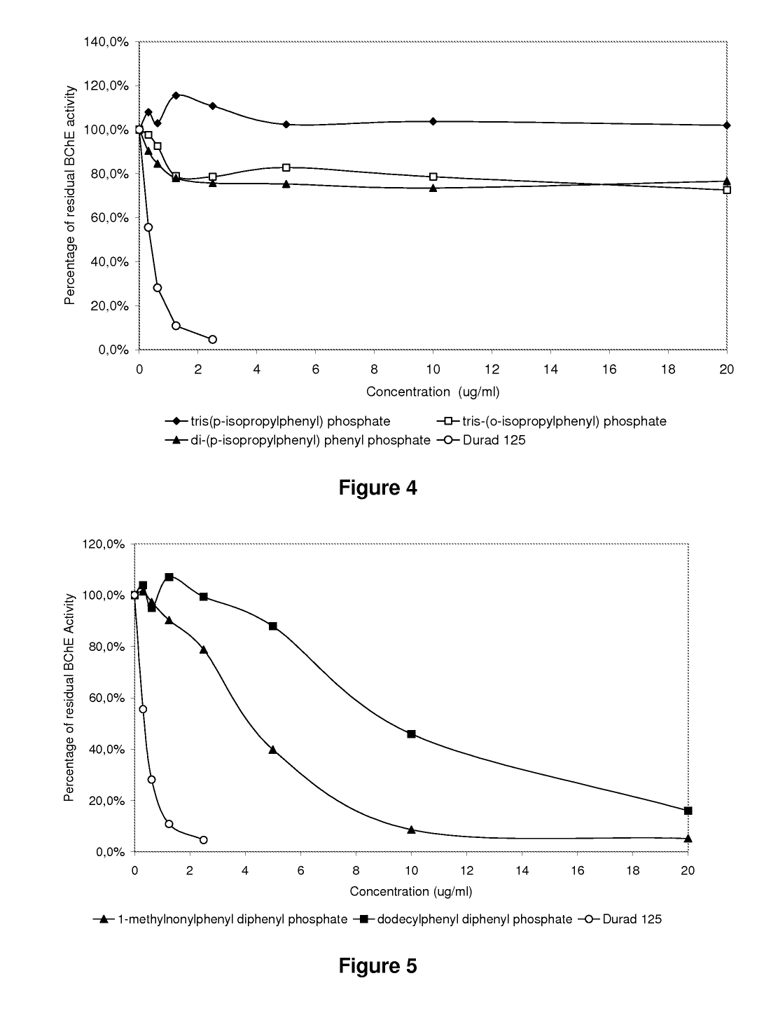

Briefly, base stock triarylphosphate solutions were prepared by dissolution or dilution of a triarylphosphate of interest in ethanol at 2.5 mg/ml. Dilution solutions were then prepared in buffer containing 10% ethanol. 7.5 μl of each dilution solution comprising a triarylphosphate was added to a liver microsome mix in phosphate buffer to give a solution comprising microsomes, NADPH (1 mM) and triarylphosphate at a concentration ranging from 0.20 to 25 μg/ml. The said concentrations of triarylphosphate are those reported in FIGS. 4a to 7. This pre-incubation was done at room temperature for 20-25 minutes. After incubation, 7.5 μl of BChE solution (at 9.75 μg/ml in phosphate buffer) was added to the resulting microsome-containing solution. The resulting solution was incubated for 20-25 minutes. The BChE residual activity was then measured as described in Example 2 hereabove.

For performing this set of experiments, several triarylphosphates were prepared as described in Example 1 (i.e by reacting appropriate phenol(s) with phosphorus oxychloride). The purity of the resulting compounds was at least 98% based on GC-MS analysis (see Example 1).

The said triarylphosphates include: tri-para-tert-butylphenyl phosphate, tri-ortho-tert-butylphenyl phosphate, tri-para -tert-butylphenyl phosphate, tri-para-isopropylphenyl phosphate, tri-ortho-isopropylphenyl phosphate, di-para-isopropylphenyl phenylphosphate, di-para-tert-butylphenyl phenylphosphate, para-tert-butylphenyl diphenyl phosphate, 1-methylnonylphenyl diphenyl phosphate and dodecylphenyl diphenyl phosphate.

For each triarylphosphates, the percentages of residual BChE activity were determined for triarylphosphate final concentrations ranging from 0.3 μg/ml to 20 μg/ml.

The Durad 125® combination was used as positive control. For reminder, Durad 125 consists in a mixture of meta and para isomers of tricresyl phosphate.

Another commercial source of tri-cresyl-phosphate of the required purity for aviation, Syn-O-Add8484® from ICL Supresta, was also tested in order to confirm the neurotoxicity of tricresylphosphates. This commercial product has a composition very close to that of Durad 125® according to GS-MS analysis (see Example 1,C8):
100% of tri-cresyl phosphate isomers resulting from the reaction of phosphoryl chloride with a mixture comprising 69% of meta-cresol and 30% of para-cresol, about 1% of xylenol mixed isomers, and less than 0.1% of ortho-cresol

For comparative purpose, the commercial product Syn-O-Add 8478 (see Example 1, C9) provided by ICL Supresta was also assessed. According to GC-MS analysis, Syn-O-Add-8478 consists of:
32% of triphenyl phosphate
43% of tert-butylphenyl diphenylphosphate isomers
22% of di-tert-butylphenyl phenylphosphate isomers and
3% tri-tert-butylphenyl phosphate isomers

b. Results

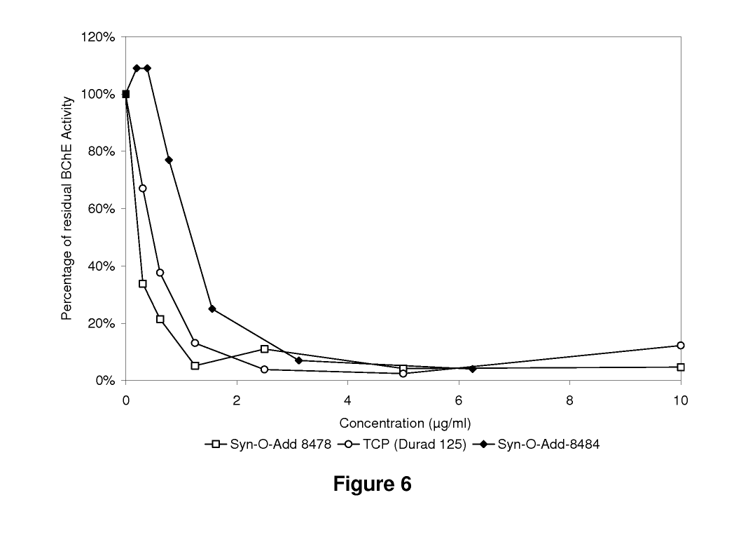

The dose-effect curves obtained by these additional assays (i.e. the percentage of BChE residual activity versus triarylphosphate compound concentration) are shown in FIGS. 4a, 4b, 5, 6 and 7. FIGS. 4a and 4b relate to tert-butylated compounds, FIG. 4 relates to isopropylated triarylphosphates, FIG. 5 relates to triphenylphosphate comprising a long-chain alkyl radical and FIG. 6 relates to Syn-O-Add-8478 and Syn-O-Add-8484. In all cases, Durad 125 was used as positive control.

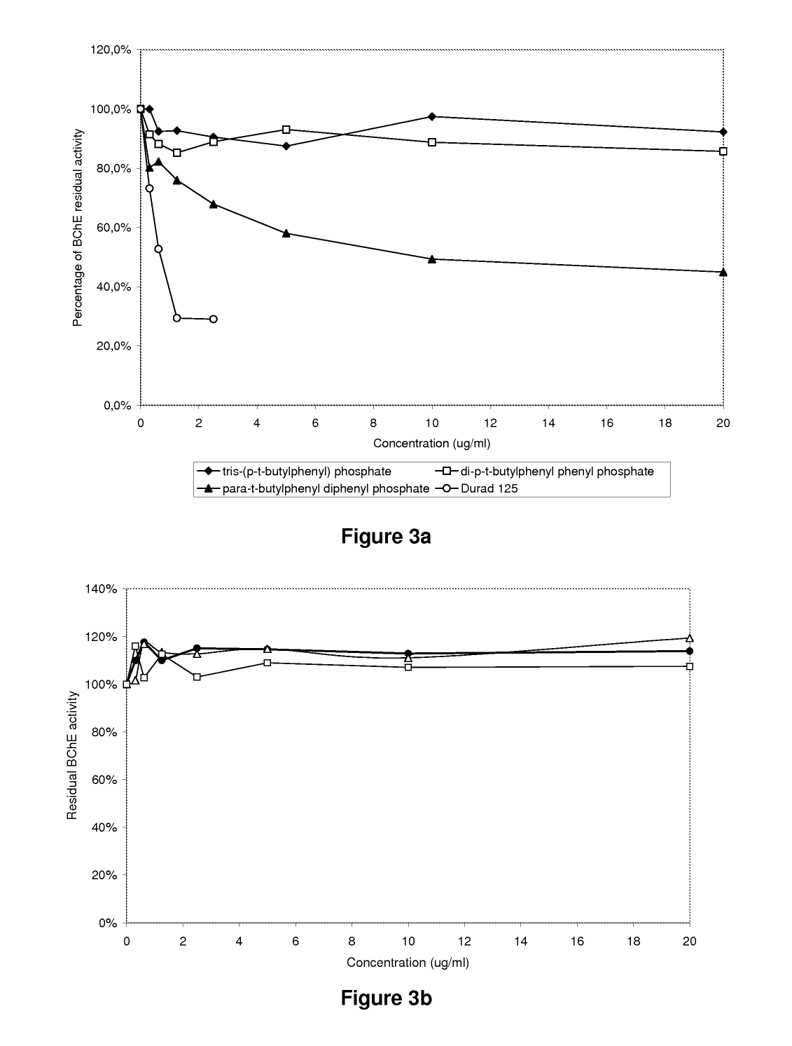

The assays corresponding to the FIG. 3a were performed in the presence of human liver microsomes. FIG. 3a clearly illustrates that tri-tert-butylphenyl phosphate and di-tert-butyl-phenyl phosphate did not induce a significant inhibition of BChE, even in high concentrations (up to 20 μg/ml). On the contrary, para-tert-butylphenyl diphenylphosphate induced an inhibition of BChE of at least 40% for concentrations higher than 5 μg/ml.

However, para-tert-butylphenyl diphenylphosphate was less active on BChE than Durad 125. Consequently, para-tert-butylphenyl diphenylphosphate remains an antiwear agent which should be preferred to be used as antiwear agent as compared to Durad 125, in view of its lower neurotoxicity.

Concerning tert-butylated triphenyl phosphates, the same results were obtained for assays performed in the presence of rat liver microsomes (RLM) (data not shown).

Interestingly, the position of alkylation did not have any impact on the ability of tri-tert-butylphenyl phosphates to inhibit BChE. As illustrated in FIG. 3b, the isomers para, meta and ortho did not inhibit BChE, after incubation with rat liver microsomes.

Similar results were obtained for isopropylated triphenyl phosphates. As illustrated in FIG. 4, isomers of tri-isopropylphenyl phosphate and of di-isopropylphenyl phenylphosphate did induce a very low inhibition of BChE in presence of RLM since the residual BChE activity was at least about 80%. Interestingly, tri-para-isopropylphenyl phosphate did not inhibit BChE

Other alkylphenyl diphenylphosphates exhibit inhibition of BChE, even if the said molecules bear a long alkyl chain such as a methylnonyl and dodecyl (see FIG. 5). However, the said mono-alkylphenyl diphenylphosphates remain less active than the triarylphosphates, such as Durad 125, which are commonly used as antiwear agents in aircraft turbine lubricating composition (see FIG. 5).

Taken together, the above results show that the number of alkyl radicals on the triphenylphosphate molecule has a real impact on the ability of said molecule to induce the inhibition of BChE after incubation with microsomes. Trialkylphenyl phenylphosphates and di-alkylphenyl phenylphosphates induce no inhibition or a very low inhibition of BChE as compared to alkylphenyl diphenylphosphate, even in the presence of long chain alkyl.

FIG. 6 also shows the dose-effect curve for the commercial Syn-O-Add-8478 and Syn-O-Add-8484. Syn-O-Add-8484 which is combination comprising tricresyl isomers induces an inhibition of BChE in the same range than Durad 125. Such a result confirms the general neurotoxicity of tricresyl isomers. In the presence of Syn-O-Add-8478, even in low concentrations, the residual activity of BChE was very low.,. Such a result clearly confirms that high amount of triphenylphosphate impairs the activity of BChE. Thus, triphenylphosphate and tricresyl isomers do not have to be used as antiwear agent to obtain a lubricating composition with reduced neurotoxicity.

On the contrary, trialkylphenyl phosphates and dialkylphenyl phenylphosphates with branched alkyl chains having from 3 to 8 carbon atoms have to be preferred as antiwear agents for obtaining lubricating compositions with reduced neurotoxicity.

Table 6 hereunder shows the minimal BChE residual activity obtained for each tested compound or combination of the Example 3 for the concentration range from 1 μg/ml to 20 μg/ml.

TABLE 6
Minimal BChE residual activity for concentrations
ranging from 1 μg/ml to 20 μg/ml

| | Microsome | Minimal BChE |
|---|---|---|
| | type | residual activity |
| Durad 125 ® | RLM | 4.6% |
| Durad 125 ® | HLM | 29.4% |
| Syn-O-Add8484 ® | RLM | 5% |
| Syn-O-Add-8478 ® | RLM | 5.1% |
| dodecylphenyl diphenyl | RLM | 16% |
| phosphate | | |
| 1-methylnonylphenyl diphenyl | RLM | 5.2% |
| phosphate | | |
| tri-para-isopropylphenyl | RLM | >100% |
| phosphate | | |
| tri-ortho-isopropylphenyl | RLM | 72.6% |
| phosphate | | |
| di-para-isopropylphenyl | RLM | 76.5% |
| phenylphosphate, | | |
| tri-para-tert-butylphenyl | RLM | >100% |
| phosphate, | | |
| tri-ortho-tert-butylphenyl | RLM | >100% |
| phosphate | | |
| tri-meta-tert-butylphenyl | RLM | >100% |
| phosphate | | |
| tri-para-tert-butylphenyl | HLM | 90% |
| phosphate, | | |
| di-para-tert-butylphenyl | HLM | 85.2% |
| phenylphosphate | | |
| para-tert-butylphenyl diphenyl | HLM | 44.9% |
| phosphate | | |

### Example 4

### Evaluating the Anti-Wear Combination Volatility

a. Experiment Protocol

The volatility of the C2, C3 and C5 commercial compositions (that is to say Durad 620B, Durad 125 and Durad 150) was measured by thermogravimetry (TGA) under nitrogen.

b. Results

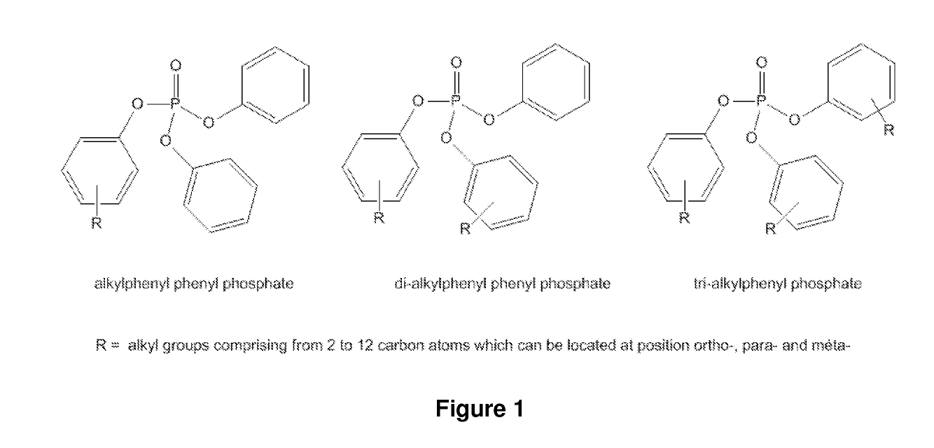

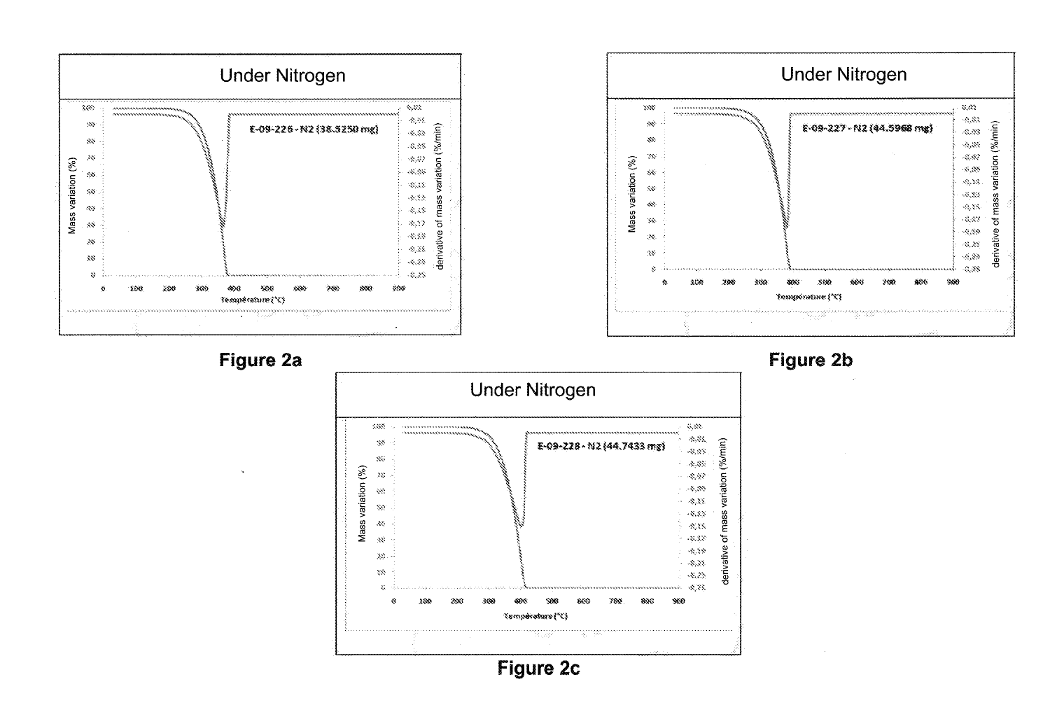

The TGA reveals that the combination of anti-wear agents of the invention (C2) has a lower volatility since the temperatures of evaporation start and evaporation end are substantially higher than those of the C3 and C5 compositions (see FIGS. 1a, 1b and 1c).

These results are summarized in Table 8 hereunder:

TABLE 8
ATG results

| | Evaporation start | Evaporation end | |
|---|---|---|---|
| | temperature ° C. | temperature ° C. | Weight loss in % |
| C5 | 205 | 380 | 100 |
| C3 | 195 | 390 | 100 |
| C2 | 225 | 420 | 100 |

### Example 5

### Evaluation of the In Vivo Neurotoxicity of Tri-Tert-Butylphenyl Phosphate as Compared to Durad 125

The activity of BChE in the plasma of rats was determined following oral administration of 240, 120, 60 and 10 mg/kg of body weight of Durad 125 or tri-para-tert-butyl phosphate at 6 hours postdosing and 24 hours postdosing. Each dose solution was prepared in a corn oil vehicle and administered by gavage. Control animals were administered an appropriate amount of corn oil (witout any triarylphosphate compounds). All animals were fasted for approximately 16 h prior to administration of the dose containing Durad 125, tri-p-t-butylphenyl phosphate or only corn oil.

Three to six animals per time point and per dose were humanely anesthetized, and sacrificed. For each animal, the blood was collected and the plasma was separated by centrifugation. The plasma samples were then stored at −80° C. until performing the BChE activity assay.

The BChE activity assay was performed as previously described according to Ellman et al (Biochem. Pharmacol. 7, 88-95).

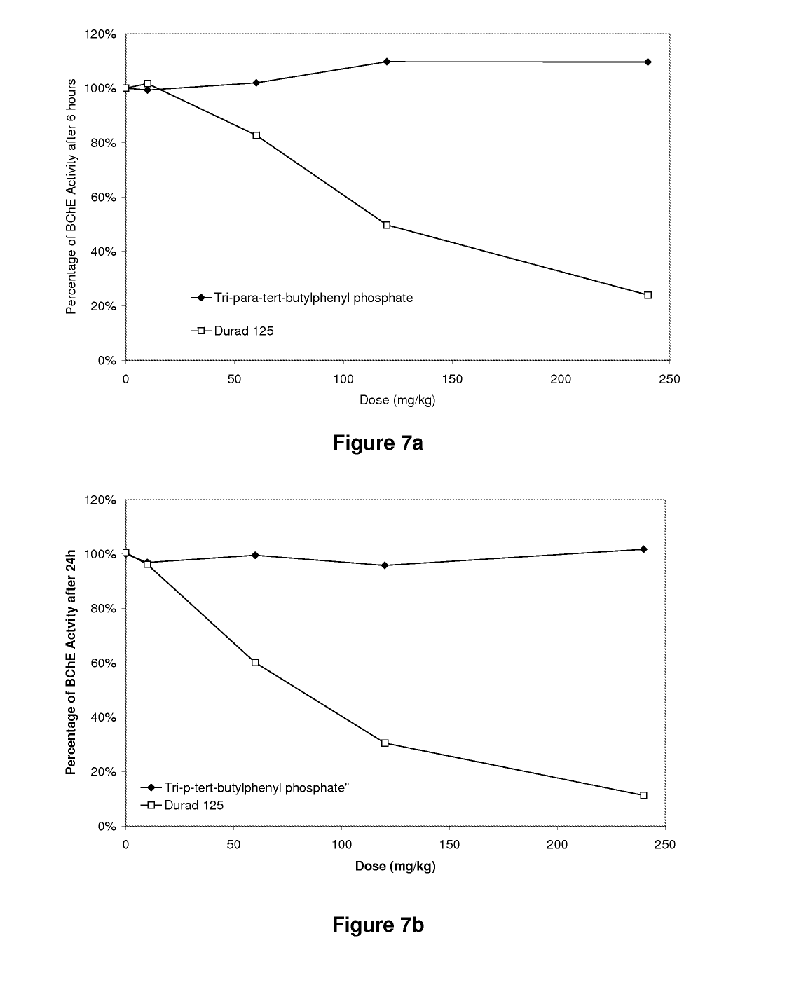

FIG. 7a and FIG. 7b shows for each dose of triarylphosphates the mean residual BChE activity in plasma at 6 hours and 24 hours post-dosing, respectively.

It clearly appears that Durad 125 which consists in tricresyl phosphate isomers with an amount of TOCP less than 0.1% induces a dose-dependent inhibition of plasma BChE at 6 hours post-dosing and 24 hours post-dosing. Interestingly, a Durad 125 dose of only 240 mg/kg induces a residual BChE activity of only 10%. On the contrary, the tri-para-tert-butyl phosphate does not induce BChE inhibition even for a dose of 240 mg/kg at 24 hours post-dosing. Such results are consistent with the in vitro results described hereabove and thus confirm the validity of the in vitro model for assessing neurotoxicity of triarylphosphates based on a pre-incubation of triarylphosphates to be tested with liver microsomes.

These results confirmed that conventional tricresyl phosphate combinations used as antiwear agent in aircraft turbine lubricant are not safe. These results also illustrate that triarylphosphates bearing branched and hindered alkyl groups as defined in the present invention may have no effect on plasmatic BChE activity and have to be preferred as anti-wear agents in aircraft turbine lubricants instead of tricresylphosphate combinations.

### Example 6

### Physico-Chemical Properties of the Lubricating Compositions According to the Invention

a. Lubricating Composition

The lubricating compositions for aircraft turbines given in Table 7 hereunder have been formulated. The F1, F4 and F5 compositions are lubricating compositions such as defined in the present invention, that is to say for which a combination of anti-wear agents with a low neurotoxicity was used. The F2 and F3 formulations correspond to control formulations, that is to say traditionally formulated compositions.

TABLE 8
Formulated lubricating compositions. Percentages are expressed as
related to the lubricating composition total weight of interest.

| Compounds | F1 | F2 | F3 | F4 | F5 | F6 |
|---|---|---|---|---|---|---|
| Polyol ester | 94.61 | 94.61 | 94.61 | 94.15 | 94.45 | 93.905 |
| (acid C5/C7/ | | | | | | |
| C8-10 and | | | | | | |
| pentaerythritol/ | | | | | | |
| dipenta- | | | | | | |
| erythritol) (%) | | | | | | |
| Anti-wear | 2.84 | 2.84 | 2.84 | 3.3 | 1.97 | 3.52 |
| triaryl | | | | | | |
| phosphate (%) | | | | | | |
| Antioxidant | 2.5 | 2.5 | 2.5 | 2.5 | 2.5 | 2.5 |
| additive (%) | | | | | | |
| Anti-corrosion | 0.05 | 0.05 | 0.05 | 0.05 | 0.05 | 0.05 |
| additive (%) | | | | | | |
| Comple- | 0 | 0 | 0 | 0 | 0.03 | 0.025 |
| mentary | | | | | | |
| anti-wear | | | | | | |
| additive (%) | | | | | | |
| triaryl | Durad | Durad | Durad | Durad | Durad | TBPP |
| phosphate | 620B | 125 | 150 | 620B | 300 | |
| antiwear agent | | | | | | |

(TBPP: tri-para-tert-butylphenyl phosphate)

b. Evaluating the Physico-Chemical Characteristics of the Formulated Lubricating Compositions

The physico-chemical characteristics of the compositions were evaluated according to the relevant applicable standards.

The obtained values were compared with the values recommended by the AS 5780 Gr. HPC standard which relates to lubricating compositions for aircraft turbines.

TABLE 10
Physico-chemical characteristics evaluated and standards used

| | Experiment | |
|---|---|---|
| Measurement | conditions | Standard |
| Cinematic viscosity | | SAE ARP 5988 |
| Acid number | | ASTM D994 |
| Acid number variation | | ASTM D994 |
| Viscosity variation at 40° C. | | SAE ARP 5988 |
| Metal coupon weight variation | | FTM-S-791-5308 |
| Oxidation/Corrosion | 72 h at 204 and | FTM-S-791-5308 |
| | 218° C. | |
| Heat stability and corrosiveness | 96 h at 275° C. | FTM-S-791-3411 |
| Anti-wear efficiency | | AIR 4978 |
| Load carrying capacity WAM | | |
| Coking resistance (hot liquid | 375° C. | SAE ARP5996 |
| process simulator HPLS) | | |

Table 11 hereafter gives the results obtained for each formulated lubricating composition.

The lubricating compositions of the invention (F1, F4, F5 and F6) have physico-chemical characteristics similar to that of the control lubricating compositions having a high triphenyl phosphate or tricresyl phosphate content.

Adding a very small percentage of a complementary anti-wear additive with a low thermal stability (traditionally not used for lubricating aircraft turbines) may significantly improve the load carrying capacity of the lubricating compositions of the invention without being prejudicial to their thermal stability (see the F5 and F6 composition).

TABLE 11
Physico-chemical characteristics of the formulated lubricating compositions

| | | | | | | | AS 5780 |
|---|---|---|---|---|---|---|---|
| | F1 | F2 | F3 | F4 | F5 | F6 | Gr. HPC |
| Cinematic viscosity at 40° C. | 25.9 | 24.1 | 24.3 | 25.0 | 25.5 | 26.0 | min. 23.0 |
| TAN | 0.19 | 0.17 | 0.22 | 0.12 | 0.32 | 0.3 | max. 1.00 |
| Oxidation-Corrosion 72 h/ | | | | | | | |
| 204° C. | | | | | | | |
| Acid number variation | 0.96 | 1.51/0.94 | 1.35/1.19 | 0.26 | 0.8 | 0.5 | max 2.0 |
| Viscosity variation at 40° C. | 11.6 | 12.2 | 10.9 | 6.4 | 10.8 | 8.1 | 0 to 22.5 |
| (%) | | | | | | | |
| Metal coupon weight | | | | | | | |
| variation | | | | | | | |
| Steel | 0.02 | 0.02 | 0 | 0.02 | 0 | 0 | ±0.2 |
| Silver | 0 | 0 | 0 | 0 | 0 | 0 | ±0.2 |
| Aluminium | 0 | 0 | 0 | 0 | 0 | 0 | ±0.2 |
| Magnesium | 0 | 0 | 0.03 | 0 | 0 | −0.03 | ±0.2 |
| Copper | −0.12 | −0.12/−0.07 | −0.08 | −0.05 | −0.2 | −0.03 | ±0.2 |
| Deposits | 0.1 | 0.8 | 1.5 | 0.3 | 0.7 | 1.1 | max 25 |
| Oxidation-Corrosion 72 h | | | | | | | |
| 218° C. | | | | | | | |
| Acid number variation | | | | 1.69 | 3.6 | 5.1 | No standardized |
| Viscosity variation at 40° C. | | | | 12.4 | 8.0 | 17 | value |
| (%) | | | | | | | recommended |
| Metal coupon weight | | | | | | | |
| variation | | | | | | | |
| Steel | | | | 0 | 0 | 0 | ±0.2 |
| Silver | | | | 0 | 0 | 0 | ±0.2 |
| Aluminium | | | | 0 | 0 | 0 | ±0.2 |
| Magnesium | | | | 0 | 0 | 0 | ±0.2 |
| Copper | | | | −0.2 | −0.2 | 0 | ±0.2 |
| Deposits | | | | 0.15 | 0.40 | 2.8 | max. 25 |
| Heat stability & Corrosion | | | | | | | |
| 96 h at 275° C. | | | | | | | |
| Viscosity variation, % | 0.27 | 0.42 | 0.35 | 0.53 | 0.59 | 0 | +/−5.0 max |
| Acid number variation, mg | 0.38 | 0.29 | 0.40 | 0.40 | 1.46 | 3.0 | 6.0 max |
| KOH/g | | | | | | | |
| Metal weight variation, | −0.09 | −0.17 | 0.02 | −0.64 | −0.2 | −0.15 | +/−4.0 max |
| mg/cm² | | | | | | | |
| Load carrying capacity | | | | | | | |
| WAM | | | | | | | |
| AIR 4978 | | | | | | | |
| Load stage | — | >20 | 21.7 | 15/17 | 23 | 24 | Mini 15 |
| HLPS SAE ARP 5996 at | | | | | | | |
| 375° C. | | | | | | | |
| Coking after 20 h (mg) | 0.10 | 0.29 | 0.21/0.23 | 0.29 | 0.13 | 0.20 | 0.4 max |
| Coking after 40 h (mg) | 0.08 | 0.30 | 0.35/0.37 | 0.26 | 0.35 | 0.39 | 0.6 max |

These results clearly showed that the lubricating compositions of the invention (such as the F1, F4, F5 and F6 compositions) are suitable for lubricating aircraft turbines.

c. Evaluating the Anti-Wear Efficiency Loss of a Lubricating Composition

When the anti-wear agent used is composed of one or more phosphorous compound(s), the anti-wear efficiency loss of the lubricating composition over time may be evaluated by measuring the phosphorous content.

950 liters of the lubricating composition to be tested are loaded in an industrial turbine of the aero-derived type Rolls-Royce 501 KB7S (i.e. derived from an aircraft engine). The turbine runs approximately 700 hours/month. Each month, the resident oil phosphorous content is measured by flame emission spectrophotometry (ICP).

When using Durad 150 (C5 triaryl phosphate composition), Table 11 hereafter shows how the oil phosphorous content does evolve over the next 7 months, despite the oil make-up which is also regularly carried out.

TABLE 12
Evolution of the phosphate content over time for an oil comprising
Durad 150 (C5) as an anti-wear agent

| | Month | | | | | | | |
|---|---|---|---|---|---|---|---|---|
| | | 1 | 2 | 3 | 4 | 5 | 6 | 7 |
| | T = 0 | month | months | months | months | months | months | months |
| Phosphorous | 2100 | 1435 | 1136 | 924 | 740 | 587 | 581 | 583 |
| (ppm) | | | | | | | | |

It is expected from an anti-wear agent or a combination of anti-wear agents according to the present invention to be slowly volatilized over time, which would enable to extend the lubricating composition lifetime and to also extend that of the expensive materials in which said lubricating composition is to be used.

1. An anti-wear agent or a combination of anti-wear agents having a reduced neurotoxicity for preparing a lubricating composition to be used in aircraft turbine engines,
(a) said anti-wear agent or each anti-wear agent of said combination being selected from the group consisting of compounds of formula A 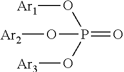
in which (i) Ar1, Ar2 and Ar3 represent aryl groups;
(ii) at least two of said Ar1, Ar2 and Ar3 are each substituted with at least one alkyl radical and
(iii) said alkyl radical(s) comprise(s) from 3 to 8 carbon atoms; and
(b) e said anti-wear agent or said combination having a minimal residual BChE activity percentage of at least 65%, according to the in vitro BChE activity assay.

2. The anti-wear agent or a combination of anti-wear agents according to claim 1 wherein the Ar1, Ar2 and Ar2 are independently selected in the group consisting of phenyl, naphthyl, meta and para isomers of xylenyl and cresyl and aryl groups comprising an alkyl radical having from 3 to 8 carbon atoms

3. The anti-wear agent or a combination of anti-wear agents according to claim 1 wherein said combination of anti-wear agents consists in:
(i) from 0% to 100% in moles of one or more compounds of formula A comprising two aryl groups among Ar1, Ar2 and Ar3 each substituted with one alkyl radical and
(ii) from 0% to 100% in moles of compounds of formula A comprising Ar1, Ar2 and Ar3 each substituted with one alkyl radical,
the percentages being expressed as related to the total number of moles of said combination of anti-wear agents.

4. The anti-wear agent or a combination of anti-wear agents according to claim 1 wherein said Ar1, Ar2 and Ar3 are all selected from the group consisting of phenyl group and mono-alkyl-phenyl groups.

5. The anti-wear agent or a combination of anti-wear agents according to claim 1 wherein said alkyl radicals having from 3 to 8 carbon atoms are selected from the group consisting of isopropyl, isobutyl, isopentyl, tert-butyl, tert-pentyl, neopentyl and neohexyl.

6. The anti-wear agent or a combination of anti-wear agents according to claim 1 wherein said anti-wear agent or said anti-wear agents of the combination are selected from tri-isopropylphenyl phosphate, tri-tert-butylphenyl phosphate, di-isopropylphenyl phenylphosphate and di-tert-butylphenyl phenylphosphate.

7. The anti-wear agent or a combination of anti-wear agents according to claim 1 wherein said anti-wear agent or said combination of anti-wear agents have a purity of at least 98% according to GS-MS analysis.

8. A lubricating composition for aircraft engine turbines, said composition comprising:
(a) at least 90% by weight of one or more long-chain ester(s) selected from the groups consisting of products resulting from the reaction of linear or branched carboxylic acids having from 4 to 12 carbon atoms with one or more polyol(s),
(b) from 1% to 5% by weight of one or more antioxidant(s),
(c) from 1% to 5% by weight of an anti-wear agent or a combination of anti-wear agents such as defined in claim 1,
(d) from 0.01% to 0.3% of one or more anti-corrosion and/or yellow metal deactivating additive(s),
the percentages by weight being expressed as related to the lubricating composition total weight.

9. The lubricating composition according to claim 8 further comprising from 0.005% to 0.3% of a complementary anti-wear additive having a low thermal stability, said percentage being expressed as related to the lubricating composition total weight.

10. The lubricating composition according to claim 9, wherein the complementary anti-wear additive having a low thermal stability is selected from the group consisting of organosulfur compounds, thioacids and thioesters, thiophosphates, thiophosphites, amine phosphates, phosphites and alkyl phosphates.

11. The lubricating composition according to claim 8, wherein the long-chain ester(s) is or are selected from products resulting from the reaction of linear or branched carboxylic acids having from 4 to 12 carbon atoms with one or more polyol(s) selected from trimethylol propane, pentaerythritol, dipentaerythritol, neopentylglycol, tripentaerythritol and ditrimethylol propane.

12. The lubricating composition according to claim 8, wherein the antioxidant(s) is or are selected from aromatic amines and aromatic amine oligomers.

13. The lubricating composition according to claim 7, wherein the anti-corrosion and/or yellow metal deactivating additive(s) is or are selected from benzotriazole derivatives.

14. The lubricating composition according to claim 8, wherein:
(i)the long-chain ester(s) is or are selected from products resulting from the reaction of pentaerythritol and dipentaerythritol with one or more carboxylic acid(s) selected from the group consisting of valeric acid, isovaleric acid, heptanoic acid, caprylic acid, nonanoic acid, isononanoic acid, 2-ethyl hexanoic acid and capric acid,
(ii) the antioxidant(s) is or are selected from diphenyl amines, phenyl- -naphthyl amines and their oligomers, these compounds being optionally substituted with one or more alkyl group(s) having from 2 to 10 carbon atoms,
(iii) the anti-corrosion and/or yellow metal deactivating additive(s) is or are selected from benzotriazole and methyl benzotriazole, and
(iv) the combination of anti-wear agents with a reduced neurotoxicity being selected from the group consisting of compounds of formula A 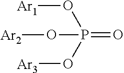
in which (i) Ar1, Ar2 and Ar3 represent aryl groups;
(ii) at least two of said Ar1, Ar2 and Ar3 are each substituted with at least one alkyl radical and
(iii) said alkyl radical(s) comprise(s) from 3 to 8 carbon atoms; and
said anti-wear agent ore said combination having a minimal residual BChE activity percentage of at least 65%, according to the in vitro BChE activity assay;
wherein said anti-wear agent ore- said anti-wear agents of the combination are selected from tri-isopropylphenyl phosphate, tri-tert-butylphenyl phosphate, di-isopropylphenyl phenylphosphate and di-tert-butylphenyl phenylphosphate.

15. A method for preparing a lubricating composition as defined in claim 7 comprising the step of:
(i) providing an anti-wear agent or a combination of anti-wear agents having reduced neurotoxicity,
(a) said anti-wear agent or each anti-wear agent of said combination being selected from the group consisting of compounds of formula A 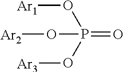
in which:
(i) Ar1, Ar2 and Ar3 represent aryl groups;
(ii) at least two of said Ar1, Ar2 and Ar3 are each substituted with at least one alkyl radical and
(iii) said alkyl radical(s) comprise(s) from 3 to 8 carbon atoms; and
(b) said anti-wear agent or said combination having a minimal residual BChE activity percentage of at least 65%, according to the in vitro BChE activity assay,
(ii) adding the anti-wear agent or said combination of anti-wear agents to one or more compounds selected from long chain esters, anti-oxidant agents and anti-corrosion agents; and
(iii) obtaining the lubricating composition for aircraft engine turbines.

16. The anti-wear agent or a combination of anti-wear agents according to claim 2 wherein said combination of anti-wear agents consists in:
(i) from 0% to 100% in moles of one or more compounds of formula A comprising two aryl groups among Ar1, Ar2 and Ar3 each substituted with one alkyl radical and
(ii) from 0% to 100% in moles of compounds of formula A comprising Ar1, Ar2 and Ar3 each substituted with one alkyl radical,
the percentages being expressed as related to the total number of moles of said combination of anti-wear agents.

17. The anti-wear agent or a combination of anti-wear agents according to claim 2 wherein said Ar1, Ar2 and Ar3 are all selected from the group consisting of phenyl group and mono-alkyl-phenyl groups.

18. The anti-wear agent or a combination of anti-wear agents according to claim 3 wherein said Ar1, Ar2 and Ar3 are all selected from the group consisting of phenyl group and mono-alkyl-phenyl groups.

19. The anti-wear agent or a combination of anti-wear agents according to claim 2 wherein said alkyl radicals having from 3 to 8 carbon atoms are selected from the group consisting of isopropyl, isobutyl, isopentyl, tert-butyl, tert-pentyl, neopentyl and neohexyl.

20. The anti-wear agent or a combination of anti-wear agents according to claim 3 wherein said alkyl radicals having from 3 to 8 carbon atoms are selected from the group consisting of isopropyl, isobutyl, isopentyl, tert-butyl, tert-pentyl, neopentyl and neohexyl.
